(19) United States
(12) Patent Application Publication
(10) Pub. No.: US 2013/0184139 A1
(43) Pub. Date: Jul. 18, 2013

(54) FREELY MOVABLE TUCKER APPARATUS AND METHOD

(71) Applicant: James Andrew Walsh, Ashland, WI (US)

(72) Inventor: James Andrew Walsh, Ashland, WI (US)

(73) Assignee: C.G. BRETTING MANUFACTURING CO., INC., Ashland, WI (US)

(21) Appl. No.: 13/350,544

(22) Filed: Jan. 13, 2012

(51) Int. Cl. B31F 1/10

(52) U.S. Cl. 493/426

(57) ABSTRACT

A movable tucker apparatus and method include a tucker element having a tip and base at opposite ends thereof, a tucker spring and a tucker positioning lug configured for operative mounting within the slot in a folding roll. The lug is operatively affixed to the roll within the slot and extends at least partly across a width of the slot. The tucker element includes a relief for operative receipt therein of the lug. The tucker element, lug and spring are operatively connected to allow the tucker element to move in and out within the slot, and the tip of the tucker to move circumferentially with respect to the slot when the tucker element is operatively mounted in the slot and the tucker positioning lug operatively disposed within the relief in the tucker element.

### FIELD OF THE INVENTION

This invention relates to folding machines and more particularly to a tucker arrangement using a freely movable tucker element for directing sheets of material passing through a nip between mating rolls of a folding machine into a gripper arrangement within the rolls.

### BACKGROUND OF THE INVENTION

For products such as facial tissues, wax paper, metal foil, poly film or hand towels, it is often desirable to interfold adjacent sheets into a stack of folded sheets in such a manner that, as each sheet is removed from a dispenser, a portion of the next sheet is also pulled from the dispenser and left exposed to facilitate removal of that sheet from the dispenser at a later time. To achieve such an arrangement, individual sheets in the stack are folded into two or more panels to form V, Z, W or other shaped sheets, with one or more panels of adjacent sheets overlapping one another to form the interfolded stack.

Such interfolded stacks are often formed with machinery utilizing a pair of cooperating interfolding rolls that are rotatably disposed with respect to one another to form a nip between the folding rolls. The interfolding rolls are configured to accomplish a desired interfolding pattern as one or more webs or sheets of material are fed through the nip. Specifically, in a typical interfolding arrangement, each of the interfolding rolls may have at least one circumferentially-spaced gripper arrangement therein which is disposed in timed relationship with at least one tucker arrangement of the other interfolding roll, in such a manner that the tucker of one roll is substantially aligned with the gripper arrangement of the other roll as the gripper arrangements of each roll respectively pass through the nip.

Typically, the gripper arrangement is recessed below the surface of the roll in which the gripper is mounted, and the tucker protrudes beyond the surface of the roll in which the tucker is mounted. In some gripper arrangements, however, the grippers protrude outside of the roll and the tuckers are recessed below the surface of the roll. Regardless of whether the gripper or the tuckers protrude outside of the roll, the tucker functions to direct one or more overlapped layers of material in to the gripper, and to assist the gripper in forming the fold, as the material passes through the nip between the folding rolls.

The tucker arrangement typically includes a tip which is configured for operative engagement with a corresponding gripper arrangement on the other roll. The tip of the tucker is used for guiding one or more sheets of material passing through the nip with the tucker into the corresponding gripper on the other roll.

For proper operation of an interfolding arrangement having tucker arrangements where the tucker protrudes beyond the periphery of the roll in which the tucker is mounted, it is generally necessary that the tip of the tucker extend beyond the periphery of both the roll to which the tucker is attached, and also past the periphery of the other roll, in order for the tip of the tucker to properly interact with the gripper carried by the other roll. In similar fashion, in tucker arrangements wherein the gripper protrudes beyond the periphery of the roll in which the gripper is mounted, it is generally necessary for the outer end of the gripper to extend beyond the periphery of both the roll to which the gripper is attached, and also past the periphery of the other roll, in order for the tip of the gripper to properly interact with the tucker carried by the other roll.

Simply stated, either the tip of the tucker, or the end of its associated gripper typically extends beyond the periphery of the roll in which the tucker or gripper is mounted and inside of the periphery of the other roll. As a result, some degree of contact and potential interference between the tips of the tuckers and their corresponding gripper arrangements is inherent in operation of such an interfolding apparatus. Such contact and interference causes undesirable noise and vibration during the interfolding process, and has necessitated the use of closely-toleranced, complex parts in order to achieve proper operation in prior interfolding apparatuses. The end of a protruding gripper, or the tip of a protruding tucker, are disposed at a greater radial distance from the rotational center of the roll in which the protruding gripper or tucker is mounted. This results in the tangential velocity of the end of the protruding gripper or the tip of a protruding tucker being higher than that of its corresponding mating part, and poses an inherent problem in the design and operation of interfolding equipment.

It has been observed in some prior gripper and tucker arrangements that the gripper may bounce off of, or out of engagement with, its associated tucker, and thus lose control of the material being folded, as a result of some of the above-described inherent design and operational problems.

Some gripper arrangements incorporate a mechanical gripping finger which clamps against an anvil of the gripper arrangement to grasp the sheets of material which have been pressed into the gripper between the end of the arm and the anvil by the tip of the tucker. As the gripper arrangement closes, the tip of the tucker is also clamped by the gripper. The tip of the tucker must somehow disengage from the gripper, preferably as smoothly as possible, as the tucker and its corresponding gripper move away from the nip as the rolls continue to rotate.

In order to facilitate the operation of interfolding apparatuses, some prior interfolding apparatuses have utilized tucker elements having unitary bodies of rigid materials which are attached to the roll by a mechanical arrangement that allows the tip of the tucker element to rotate slightly in a circumferential direction or to be moved radially inward as a result of contact with the gripper arrangement. Although, such prior moveable tuckers have involved considerable mechanical complexity, they have not provided performance that is entirely satisfactory. Examples of such prior approaches to providing moveable tucker arrangements are provided by: U.S. Pat. No. 1,871,301 to Campbell; U.S. Pat. No. 2,092,952 to Campbell; U.S. Pat. No. 1,595,992 to Cannard; U.S. Pat. No. 2,468,254 to Deloye; U.S. Pat. No. 4,270,744 to Trogan; and U.S. Pat. No. 4,822,328 to Bertolini.

Movable tucker arrangements in such prior interfolding apparatuses have been limited to a small range of motion in substantially only one direction. Smooth operation during interfolding would be facilitated by having a tucker that has a greater range and freedom of movement in a more complex path involving simultaneous movement in more than one direction.

U.S. Pat. No. 7,771,337 to White et al., titled “Self-Centering Tucker Assembly for a Folding Roll,” discloses a tucker assembly having a tucker element that is both spring loaded in a radially outward opening slot in a folding roll and pivotably mounted within the slot to allow the tucker to pivot within the slot and retract within the slot against a biasing force of the spring. While this arrangement does allow the tucker element of White to both pivot about a pivot axis and retract in the slot, the arrangement is mechanically overly complex and too cumbersome to be practical. The restrictions imposed by the structure of White being constrained to pivot about an axis result in the tucker of White not being freely movable enough to provide either a desired smooth operation of a gripper interacting with the tucker of White, or optimal interaction of a pair of folding rolls including the tucker of White.

Generally speaking, and to address one or more of the shortcomings discussed above, further improvement is desirable in tucker and interfolding apparatuses, and in methods for dealing with problems associated with interaction between the tip of the tucker and the gripper apparatus.

### BRIEF SUMMARY OF THE INVENTION

The invention provides an improved tucker apparatus and method having a more freely movable tucker, through use of a tucker element having a tip and base at opposite ends thereof, a tucker spring and a tucker positioning lug configured for operative mounting within the slot in a folding roll. The lug is operatively affixed to the roll within a slot in a folding roll and extends at least partly across a width of the slot. The tucker element includes a relief for operative receipt therein of the lug. The tucker element, lug and spring are operatively connected and/or cooperative configured to allow the tucker element to move in and out within the slot, and the tip of the tucker to move circumferentially with respect to the slot in the roll, when the tucker element is operatively mounted in the slot with the base of the tucker element juxtaposed with the bottom of the slot in the roll and the tucker positioning lug operatively disposed within the relief in the tucker element.

In some forms of the invention, a moveable tucker apparatus is provided for a folding roll defining an outer circumferentially extending surface of the roll, and a rotational axis of the folding roll. A longitudinal length of the folding roll extends between first and second axial ends of the folding roll. The folding roll also has therein an outwardly opening tucker slot having a slot length extending along the rotational axis of the roll. The slot also defines opposite sidewalls of the slot spaced from one another by a slot width, and joined to one another by a bottom surface of the slot. A distance from the bottom of the slot to the outer circumferentially extending surface of the roll defines a depth of the slot.

In one form of the invention, a freely moveable tucker apparatus includes a tucker element having a tip and a base at opposite ends thereof, a tucker spring and a tucker positioning lug configured for operative mounting within the slot in the folding roll. The tucker positioning lug is operatively affixed to the roll within the slot and extends outward into the slot in a direction away from at least one of the slot sidewalls at least partially across the width of the slot. The tucker element includes a relief for operative receipt therein of the tucker positioning lug. The tucker element, tucker positioning lug and spring are operatively connected in a manner allowing the tucker element to move in and out within the slot, and in such a manner that the tip of the tucker can move circumferentially with respect to the slot in the roll, when the tucker element is operatively mounted in the slot with the base of the tucker element juxtaposed with the bottom of the slot in the roll and the tucker positioning lug operatively disposed within the relief in the tucker element.

In one form of the invention, the tucker element defines a central plane extending through the tip and a base of the tucker element. When the tucker element is positioned within the slot of the folding roll, the central plane of the tucker element passes through the rotational axis of the roll.

In another form of the invention, a freely moveable tucker apparatus, according to the invention, includes a tucker element, a tucker spring and a tucker positioning lug configured for operative mounting within the slot in the folding roll. The tucker element has a tucker body defining a tucker axis extending between a tucker tip and a tucker base at opposite axial ends of the tucker body and defining a tucker element length that is less than the slot depth between the tip and base of the tucker element.

The tucker element and slot are cooperatively configured such that the tucker element is mountable within the slot in a manner allowing the tucker element to move inward and outward within the slot. The tucker element and slot are also cooperatively configured such that, when the tucker element is mounted within the slot, the tip of the tucker element is moveable circumferentially with respect to the slot.

The tucker positioning lug has a depth less than the depth of the slot, and is operatively affixed to the roll within the slot in such a manner that the positioning lug extends outward into the slot in a direction away from the at least one of the slot sidewalls and at least partly across the width of the slot. The tucker positioning lug further has an inward facing tucker element positioning surface thereof juxtaposed with the bottom of the slot and configured for engagement with the tucker element.

The tucker element body includes a relief configured for operative receipt therein of the tucker positioning lug. The relief in the tucker element body has a length along the tucker element axis that is greater than the depth of the tucker positioning lug. The relief also defines at a lower end thereof an outward facing tucker element positioning surface configured for operative engagement with the inward facing tucker element positioning surface of the positioning lug, for limiting outward movement of the tucker element within the slot.

The spring is operatively disposed between the roll and the tucker body for urging the tucker element outward toward engagement of the outer facing tucker positioning surface of the tucker element relief with the inward facing tucker positioning surface of the tucker positioning lug.

In some forms of the invention, the inward and outward facing tucker positioning surfaces may extend transversely to the central plane of the slot when engagement with one another. In various forms of the invention, the inward and outward facing tucker positioning surfaces may have a shape from the groups of shapes consisting of: flat, curved, multi-faceted, and angled. The inward and outward facing tucker element positioning surfaces may also be configured for facilitating movement of the tip of the tucker element circumferentially with respect to the slot in the folding roll.

In some forms of the invention, the tucker element body may be spaced from the slot sidewalls, or from a tucker element mounting arrangement disposed within the slot.

In some forms of the invention, the relief in the tucker element may take the form of an opening which extends completely through the tucker body in a direction transverse to the central plane of the slot.

In some forms of the invention, the tucker element body includes first and second sidewalls thereof juxtaposed respectively with the first and second slot sidewalls. The first and second sidewalls of the tucker element may include tucker guide segments thereof disposed adjacent the outward facing tucker element positioning surface and configured for sliding engagement with the slot sidewalls. In some forms of the invention, the tucker guide segments may be convex. In some forms of the invention, the body of the tucker element may have a greater width across the tucker guide surfaces in a direction perpendicular to the tucker central plane than either the tip or the base of the tucker element. The width across the tucker guide surfaces may be less than the slot width by a clearance width. A portion of at least one of the first and second sidewalls of the tucker element body may form a substantially straight segment connecting one of the tucker guide segments with the tip or the base of the tucker element.

In some forms of the invention, the spring may engage the tucker element above the outward facing tucker element positioning surface.

Some forms of the invention may include a tucker mounting arrangement configured for fixed installation into the slot in the roll, with the tucker mounting arrangement including the tucker positioning lug. A tucker mounting arrangement, according to the invention, may also include at least one fluid passage extending therethrough to provide fluid communication between fluid passages in the roll and fluid ports in the mounting arrangement positioned adjacent the tip of the tucker.

The invention may also take the form of a folding roll apparatus comprising a folding roll and a moveable tucker arrangement according to the invention.

The invention may also take the form of a method for constructing or operating a folding roll apparatus including a folding roll and a moveable tucker arrangement according to the invention. One form of a method, according to the invention, includes operating the folding roll with the moveable tucker element operatively mounted in the slot with the base of the tucker element juxtaposed with the bottom of the slot in the roll and the tucker positioning lug operatively disposed within the relief in the tucker element, in such a manner that the tucker element is caused to move in one or more of the motions in the group of motions consisting of: in and out within the slot; and such that the tip of the tucker moves circumferentially with respect to the slot in the roll.

In some forms of the invention, the first and second sidewalls of the tucker element body may engage the sidewalls of the slot in a rocking relationship as the tip of the tucker element moves circumferentially with respect to the slot in the folding roll. In some embodiments of the invention, the inward and outward facing tucker element positioning surfaces may also engage one another in a rocking relationship during circumferential movement of the tip of the tucker element with respect to the slot. In some forms of the invention, rocking interaction may occur sequentially and/or simultaneously at the intersection of the inward and outward facing tucker positioning surfaces and also at the intersection of one or the other of the first and second sidewalls of the tucker element body with the slot sidewalls or the tucker element mounting arrangement.

Those having skill in the art will appreciate that a moveable tucker apparatus and/or method according to the invention provides considerably freer movement of the tucker element and particularly the tip of the tucker element than can be achieved by prior moveable tucker apparatuses and methods.

Other aspects, objects and advantages of the invention will become more apparent from the following detailed description and accompanying drawings when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 and 2 are perspective illustrations of a first exemplary embodiment of a movable tucker apparatus, according to the invention, with FIG. 1 showing the movable tucker apparatus in an exploded view, and FIG. 2 showing the movable tucker apparatus in an assembled view.

FIG. 3 is a partially-exploded perspective illustration of a second exemplary embodiment of the invention, in the form of a folding roll apparatus including a plurality of movable tucker apparatuses according to the invention.

FIG. 4 is a cross-sectional illustration through the folding roll of FIG. 3, showing a number of movable tucker apparatuses, according to FIG. 1, installed in the folding roll.

FIG. 5 is an enlarged view of a tucker element of the first exemplary embodiment of the movable tucker apparatus shown in FIGS. 1-4.

FIG. 6 is an illustration of various features and attributes of the first exemplary movement of the movable tucker apparatus shown in FIGS. 1-4.

FIGS. 7-11 sequentially illustrate operation of the first exemplary embodiment of the movable tucker apparatus when installed in a pair of folding roll apparatuses according to the second exemplary embodiment of the invention.

FIGS. 7A-11A are enlarged illustrations of portions of FIGS. 7-11 taken approximately at a nip between the folding roll apparatuses.

FIGS. 8B-8D are enlarged illustrations, similar to FIG. 8A, illustrating various modes of movement of a movable tucker element according to the invention.

FIGS. 12-16 illustrate a third, fourth, fifth, sixth and seventh exemplary embodiment of a movable tucker apparatus, according to the invention.

FIG. 17 illustrates an eighth exemplary embodiment of a moveable tucker apparatus, according to the invention.

FIG. 18 illustrates an end view of the movable tucker apparatus of FIGS. 1 and 2.

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

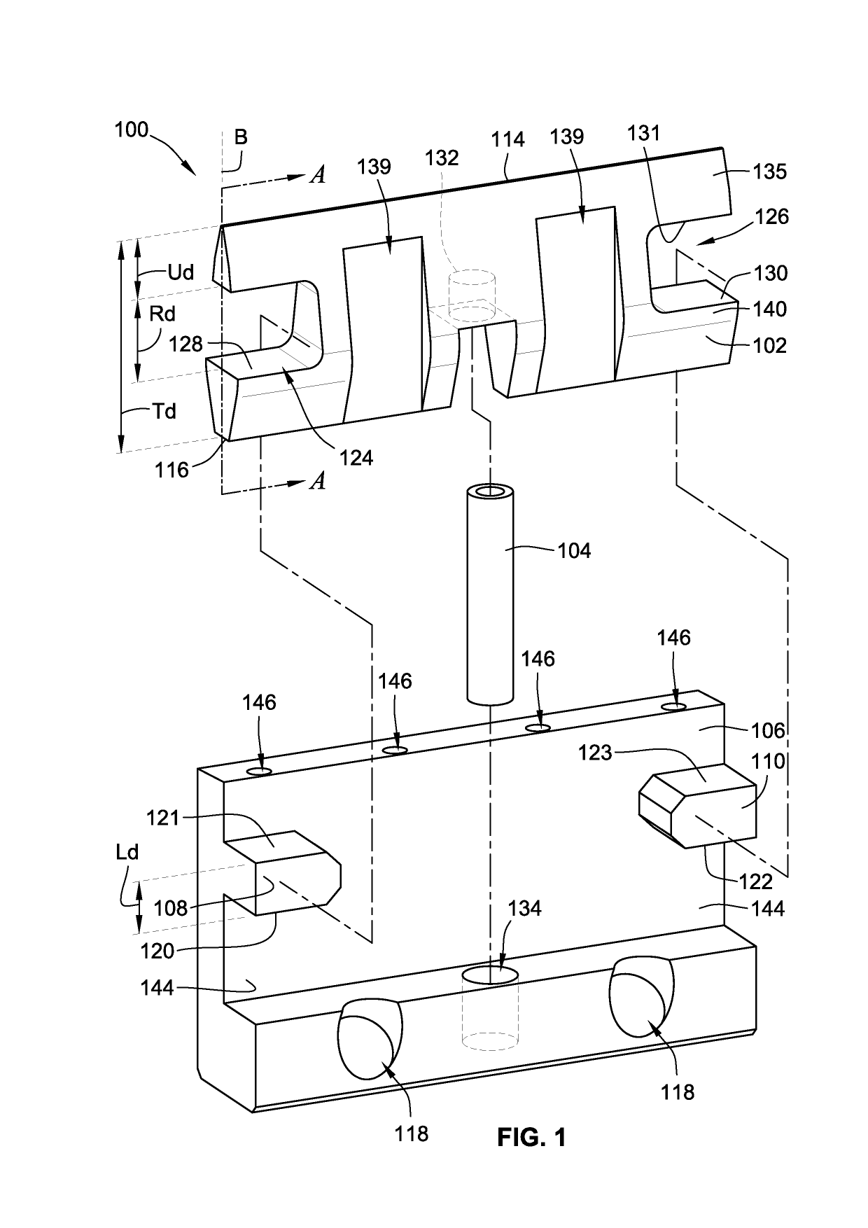

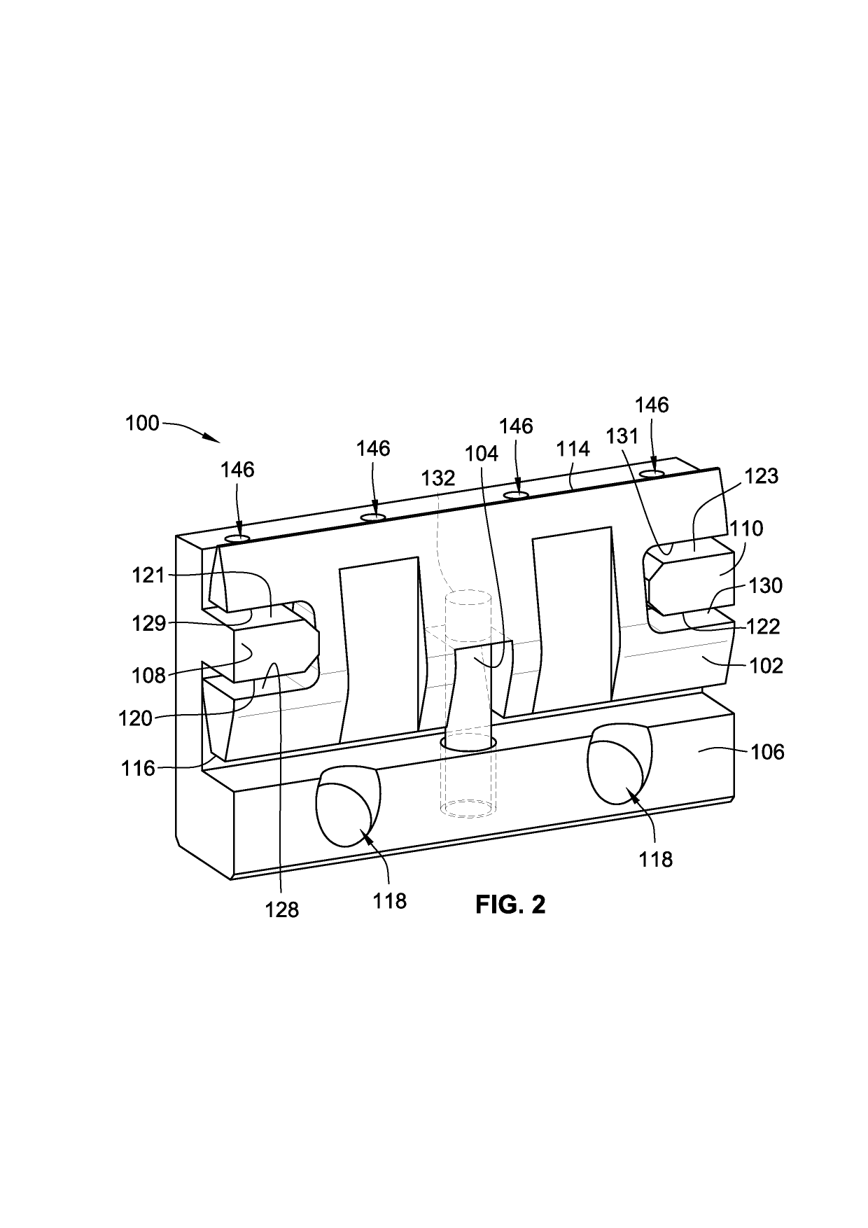

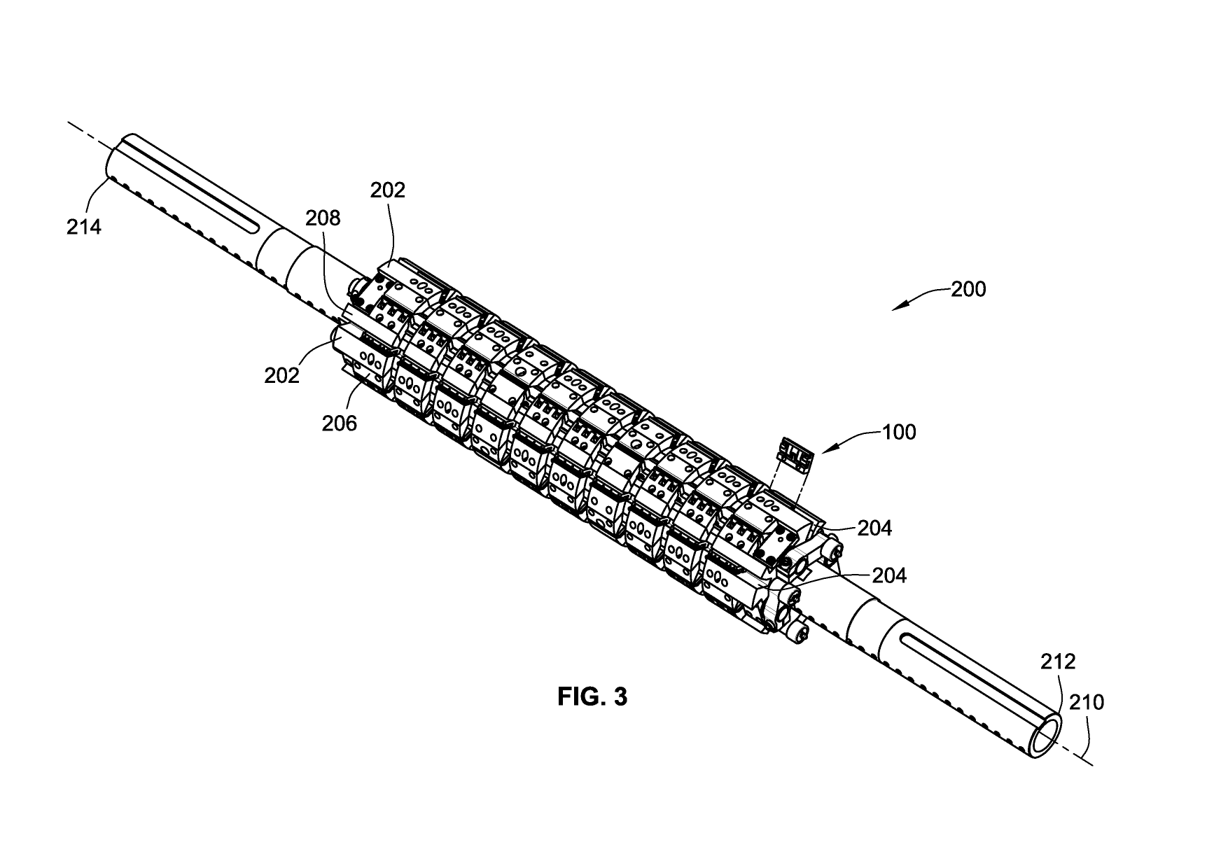

FIGS. 1 and 2 are, respectively, exploded and assembled perspective illustrations of a first exemplary embodiment of a moveable tucker apparatus 100, according to the invention. As shown in FIGS. 1 and 2, the first exemplary embodiment of the moveable tucker apparatus 100 includes a tucker element 102 (also referred to herein as a “tucker body 102”), a tucker spring 104, and a tucker mounting arrangement 106 which includes first and second tucker mounting lugs 108, 110. The first exemplary embodiment of the tucker apparatus 100 is configured for operative mounting within a slot in a folding roll apparatus, such as the folding roll apparatus 200 illustrated in FIG. 3.

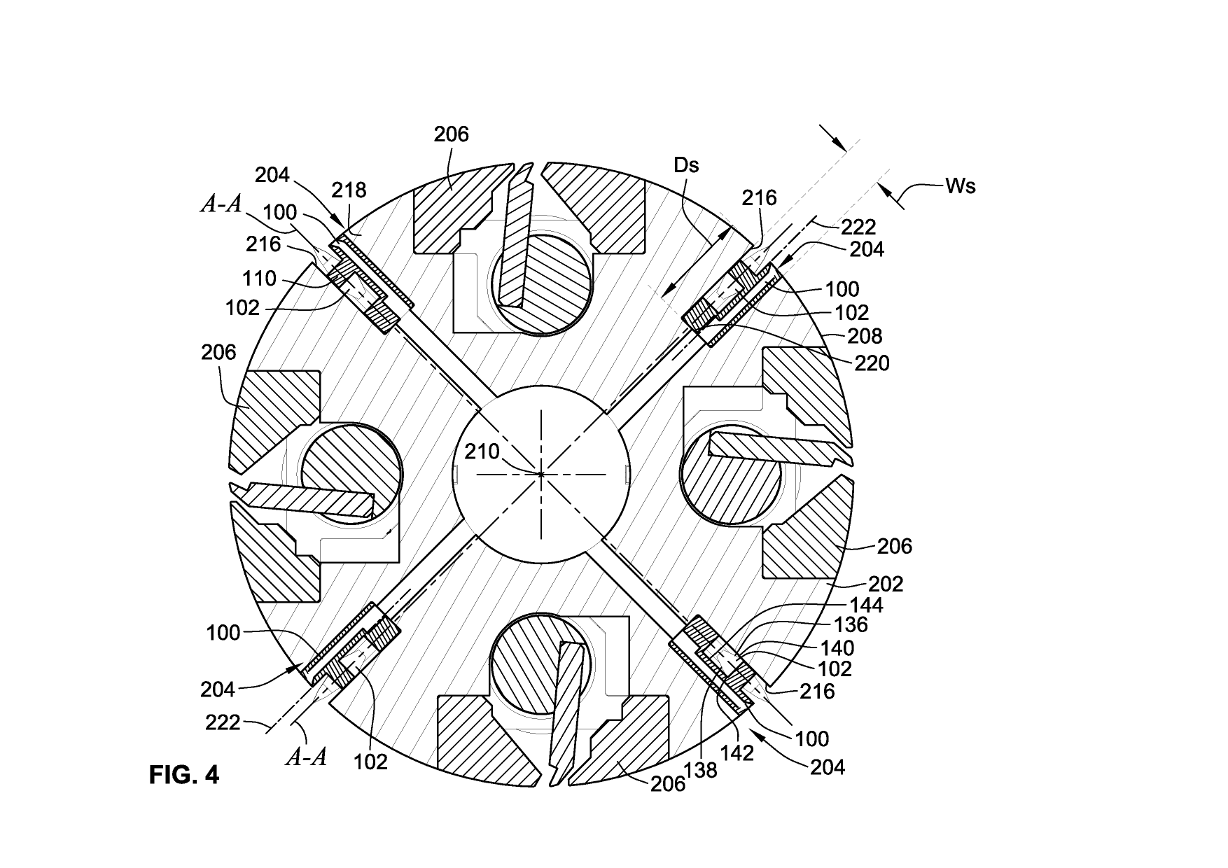

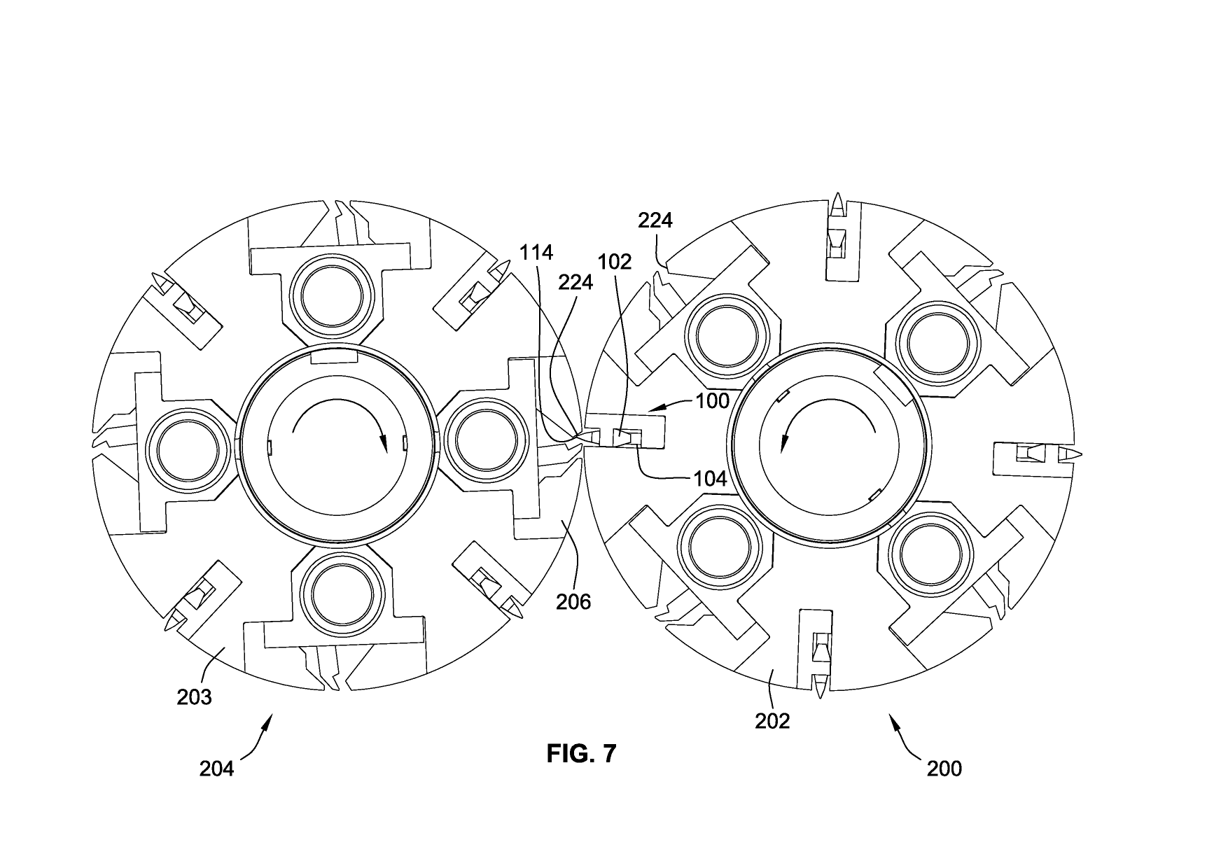

FIGS. 3 and 4 illustrates a second exemplary embodiment of the invention in the form of a folding roll apparatus 200 including a folding roll 202 having a plurality of slots 204 therein configured for receiving a plurality of moveable tucker apparatuses according to the invention, such as the first exemplary embodiment of the moveable tucker apparatus 100 shown in FIGS. 1 and 2. The roll apparatus 200 also includes a plurality of gripper arrangements 206 mounted between the moveable tucker apparatuses 100 in slots in the roll 202, in a manner known in the art. In use, a folding apparatus will utilize two roll apparatuses 200, arranged in a counter-rotating side-by-side arrangement, as shown in FIGS. 7-11, to form a nip between the folding rolls 200 through which one or more streams of material to be folded will be directed. The pair of folding roll apparatuses 200 is timed such that the tucker elements 100 of one of the rolls will interact with a corresponding one of the gripper arrangements 206 on the other folding roll apparatus 200 to create a fold in the material passing through the nip, in the manner known in the art.

As further shown in FIGS. 3 and 4, the folding roll 202 defines an outer circumferentially extending surface 208. The folding roll 202 also defines a rotational axis 210 of the folding roll extending between first and second axial end 212, 214 of the roll 202.

As shown in FIG. 4, the tucker slots 204 open outwardly through the circumferentially extending surface 208 of the folding roll and, as shown in FIG. 3, have a slot length extending along the rotational axis 210 of the roll 202. Each of the slots 204 defines opposite sidewalls 216, 218 by a slot width Ws and joined to one another by a bottom surface 220 of the slot 204. A distance from the bottom surface 220 of the slot 204 to the outer surface 208 of the roll 202 defines a depth Ds of the slot.

As shown in FIG. 1, the tucker element 102 is a unitary body defining a tucker central plane, as indicated by arrows A-A in FIG. 1, extending longitudinally through the tucker element 102. The tucker central plane A-A passes through a tucker tip 114 and generally bisects a tucker base 116 at opposite axial ends of the tucker element 102. In the exemplary embodiment, when the tucker element 102 is mounted in slot 204, tucker central plane A-A passes through rotational axis 210 of roll 202.

In some embodiments of the invention, the tucker element 102 may be formed of a polymer material, such as nylon.

The tucker element 102 defines a tucker element axial depth Td that is less than the slot depth Ds between the tip 114 and the base 116 of the tucker element 102. As will be understood from the description herein of the first exemplary embodiment of the tucker apparatus 100, the tucker element 102 and the slot 204 are cooperatively configured such that when the tucker apparatus 100 is mounted within the slot 204, the tucker element 102 of that particular tucker apparatus 100 can move inward and outward within the slot 204 in such a manner that the tip 114 of the tucker is extended or retracted to various degrees with respect to the outer surface 208 of the roll 202. As will be also understood from the description herein, the tucker element 102 and slot 204 are also cooperatively configured such that the tip 114 of the tucker element 102 is moveable circumferentially with respect to the slot 204 in which the tucker apparatus 100 is mounted.

As shown in FIG. 1, the tucker element positioning lugs 108, 110 each have a radial depth Ld that is less than the depth Ds of the slot. The lugs 108, 110 are operatively affixed to the roll 202 within the slot 204 by fasteners (not shown) which pass through a pair of mounting holes 118 at a radially inner end of the mounting arrangement 106 to fixedly attach the mounting arrangement 106 and moveable tucker apparatus 100 to the roll 202 within the slot 204. As will be understood from an examination of FIGS. 1 and 4, when the first exemplary embodiment of the moveable tucker apparatus 100 is mounted within a slot 204 in the roll 202, the tucker positioning lugs 108, 110 extend outward into the slot 204 in a direction away from at least one of the slot sidewalls 216, 218, with the lugs 108, 110 extending at least partly across the width Ws of the slot 204.

As shown in FIG. 1, each of the tucker positioning lugs 108, 110 further includes a radially inward facing tucker element positioning surface 120, 122, respectively, juxtaposed with the bottom surface 220 of the slot 204 when the moveable tucker apparatus 100 is mounted within the slot 204. The inward facing tucker element positioning surfaces 120, 122 of the first and second tucker positioning lugs 108, 110, respectively, are configured for engagement with the tucker element 102 in a manner described in further detail below.

As shown in FIG. 1, the tucker element body 102 includes a first and a second relief 124, 126 at opposite longitudinal ends of the tucker body 102 configured for operative receipt therein of a respective one of the tucker positioning lugs 108, 110. Specifically, in the first exemplary embodiment of the moveable tucker apparatus 100, the first relief 124 in the tucker element 102 is configured for operative receipt therein of the first lug 108 of the tucker mounting arrangement 106, and the second relief 126 of the tucker element 102 is operatively configured for operative receipt therein of the second tucker positioning lug 110 of the tucker mounting arrangement 106. As illustrated in FIG. 1, each of the reliefs 124, 126 in the tucker element 102 has a length Rd along the tucker element radial axis B that is greater than the radial depth Ld of the tucker positioning lugs 108, 110. Each of the reliefs 124, 126 in the tucker element 102 also includes a respective outward facing tucker element positioning surface 128, 130 at a lower, or radially inward, end of the relief 124, 126. The outward facing tucker element positioning surfaces 128, 130 are configured for operative engagement with a respective one of the inward facing tucker element positioning surfaces 120, 122 of the first and second tucker positioning lugs 108, 110 for limiting outward movement of the tucker element 102 within the slot 204 in a manner described in more detail below.

The tucker positioning lugs 108, 110 also axially position and limit axial motion, if any, of the tucker element 102 along or parallel to the rotational axis 210 of the roll 202. More particularly, laterally inward facing surfaces of the tucker positioning lugs 108, 110, extend between surfaces 120, 121 and 122, 123 of the tucker positioning lugs 108, 110. The surface of tucker positioning lug 108 generally faces the surface of tucker positioning lug 110. These surfaces of the tucker positioning lugs 108, 110 interact with and abut surfaces of the tucker element 102 that extend between inward facing stop surfaces 129, 131 and outward facing tucker positioning surfaces 128, 130. The surfaces of the tucker element 102 generally face away from one another.

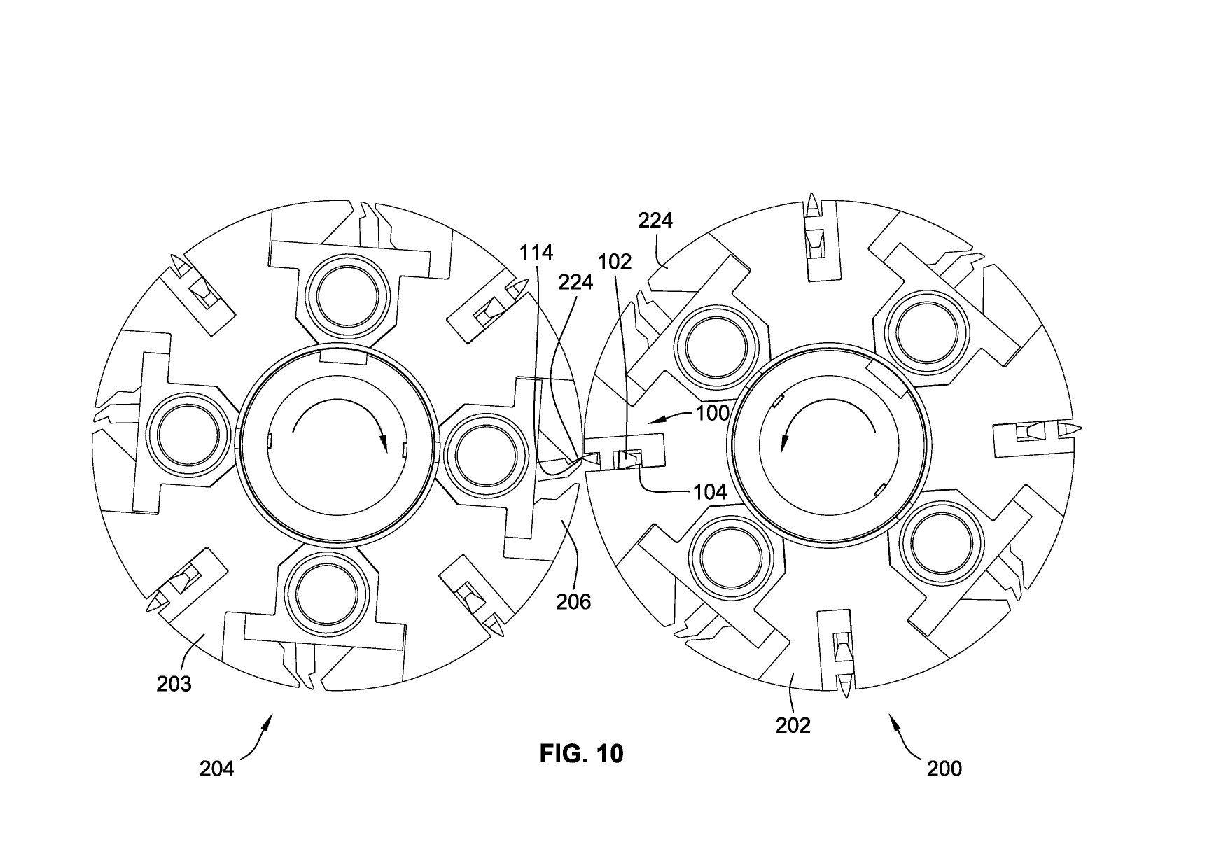

As shown in FIGS. 1 and 2, the spring 104 is operatively disposed between the roll 202 and the tucker body 102 for urging the tucker element 102 outward toward engagement of the outward facing tucker positioning surfaces 128, 130 with their respective inward facing tucker positioning surfaces 120, 122 of the first and second tucker positioning lugs 108, 110. Specifically, as illustrated in FIG. 1, the outer and inner ends of the spring 104 are respectively received in a recess 132 in the tucker element 102, and a second recess 134 in the tucker element mounting arrangement 106. As shown in FIGS. 1 and 2, the spring 104 in the exemplary embodiment of the tucker apparatus 100 is a compression spring which may take any appropriate form, such as a helically wound compression spring, or be formed form an appropriately shaped elastomeric material. It will be further understood that although only one spring 104 is shown in the exemplary embodiments of FIGS. 1 and 2, in other embodiments of the invention more than one spring may be utilized, as shown in FIG. 12 and discussed below. It will be further understood that in practicing the invention, the spring may take any appropriate form.

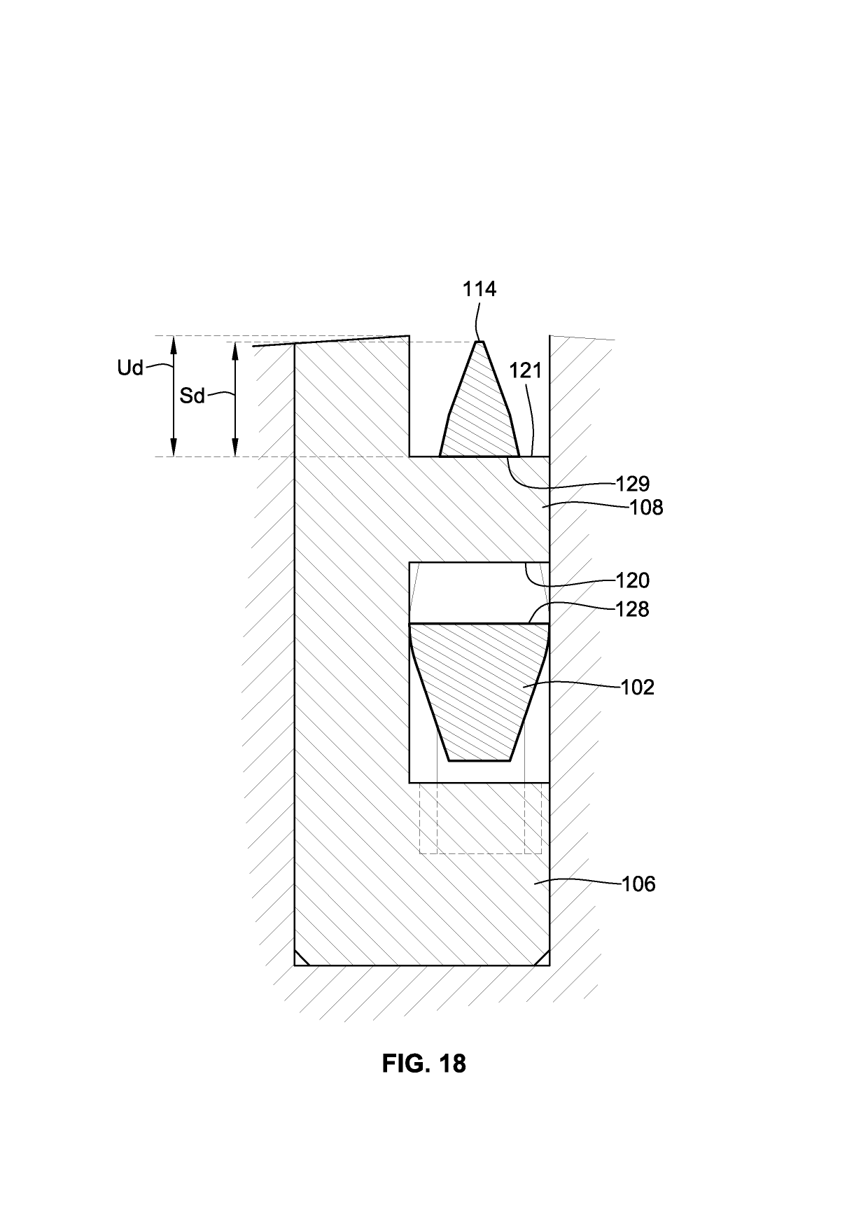

With reference to FIG. 18, the reliefs 124, 126 also includes a respective inward facing stop surface 129, 131. The inward facing stop surfaces 129, 131 are configured for operative engagement with a respective one of outward facing stop surfaces 121, 123 of the first and second tucker positioning lugs 108, 110. The engagement between the inward facing stop surfaces 129, 131 and the outward facing stop surfaces 121, 123 is configured to limit the amount of radial movement permitted by the tucker element 102 within slot 204. More particularly, the geometry of recesses 124, 126 and the lugs 108, 110 is such that the amount of compression of the spring 104 is limited. This prevents over compressing the spring 104 to prevent the spring 104 from failing.

Additionally, the upper portions 133, 135 of the tucker element 102 positioned between the respective reliefs 124, 126 that define inward facing stop surfaces 129, 131 has a length Ud. Similarly, a length between the outward facing stop surfaces 121, 123 and the outer periphery of roll 202 has a depth Sd. In an exemplary embodiment, the length Ud is no greater than and preferably less than the depth Sd such that the tip 114 of the tucker element 102 can be fully pressed into the slot 204 such that the tip 114 does not extend radially outward beyond the outer periphery of the roll 202. This will allow the tucker element 102 to compress into slot 204 and below the outer periphery of the roll 202 such that the tip 114 can clear the way for large amounts of material (i.e. a wad of material) to pass through the nip between the folding rolls. This also allows the tucker element 102 to compress into slot 204 in the event of any mechanical interference between the components of the opposed rolls due to mistiming.

In the first exemplary embodiment of the moveable tucker apparatus 100, the inward and outward facing tucker positioning surfaces 120, 122, 128, 130 are flat and extend substantially transversely to the central plane 222 of the slot 204 when in engagement with one another. Specifically, in the first exemplary embodiment of the tucker apparatus 100, the inward and outward facing tucker positioning surfaces 120, 122, 128, 130 extend substantially perpendicular to the central plane 222 of the slot 204 when in engagement with one another. It will be understood, however, that in other embodiments of the invention a moveable tucker apparatus according to the invention may utilize inward and outward facing tucker positioning surfaces having a shape or orientation different from those shown in the first exemplary embodiment of the moveable tucker apparatus 100, such as those shown in FIGS. 12-14 discussed in more detail below. For example, the inward and outward facing tucker positioning surfaces may have a variety of shapes in practicing the invention, such as flat, curved, multi-faceted, angled, etc. It will also be understood that, although the tucker mounting arrangement 106 and tucker element 102 of the first exemplary embodiment of the tucker apparatus 100 are essentially configured for symmetry in a longitudinal direction, such that the tucker element 102 may be installed in the tucker mounting arrangement 106 in either of two orientations, in other embodiments of the invention having multiple tucker positioning lugs and corresponding reliefs, the configuration of the lugs and reliefs may be made asymmetrical such that the tucker element may only be attached to the tucker element mounting arrangement in one configuration.

From the description herein, it will be appreciated that the configuration and orientation of the inward and outward facing tucker element positioning surfaces 120, 122, 128, 130, in the exemplary embodiment of the tucker apparatus 100 are configured to facilitate movement of the tip 114 of the tucker element 102 circumferentially with respect to the slot 204. The first exemplary embodiment of the tucker apparatus 100 includes additional features for facilitating circumferential positioning and alignment of the tip 114 of the tucker element 102 in a manner described in more detail below. By virtue of the configuration and orientation of the inward and outward facing tucker element positioning surfaces 120, 122, 128, 130 the inward facing tucker element positioning surfaces 120, 122 serve to cause the tucker element 102 to move circumferentially back into a position wherein the central plane A-A of the tucker element 102 is substantially parallel to the central plane 222 of the slot 204 as the outward facing tucker element positioning surfaces 128, 130 come to rest against the inward facing tucker positioning surfaces, as the tucker element 102 is urged outward by the spring 104.

It will be understood that in some embodiments of the invention, the tucker mounting arrangement 106 may take a different form, or the tucker positioning lugs may be attached directly to or formed by one of the sidewalls of the slot in a folding roll.

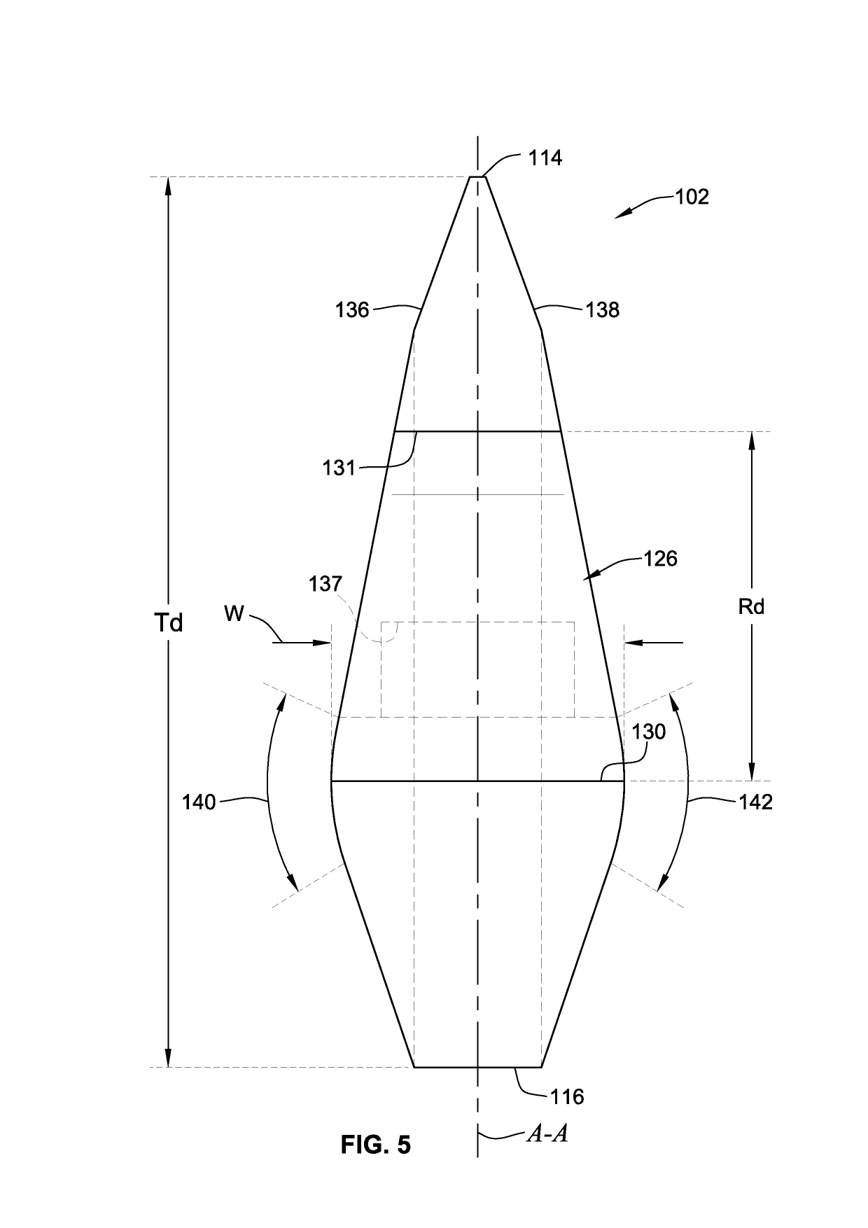

As shown in FIGS. 4 and 5, the tucker element 102 includes first and second sidewalls 136, 138 juxtaposed respectively with the first and second sidewalls 216, 218 of the slot 204, when the tucker apparatus 100 is mounted within the slot 204. As shown in FIGS. 4 and 5, the first and second sidewalls 136, 138 of the tucker element 102 have tucker guide segments 140, 142 disposed adjacent the outward facing tucker element positioning surfaces 128, 130. In the first exemplary embodiment of the tucker apparatus 100, the first guide segment 140 is configured for sliding and rocking engagement with the first slot sidewall 216. The second guide surface 142 is configured for sliding and rocking engagement with a pseudo-slot sidewall 144 of the tucker mounting arrangement 106. It will be understood, however, that in other embodiments of the invention, the second guide segment 142 of the tucker element 102 may directly contact the second sidewall 218 of the slot 204.

In the tucker element 102 of the first exemplary embodiment of the tucker apparatus 100, both the first and second guide segments 140, 142 are convex-shaped, but in other embodiments of the invention the guide surfaces may take other appropriate shapes. As shown in FIG. 5, the tucker element 102 of the tucker apparatus 100, the first and second sidewalls 136, 138 of the tucker element 102 are essentially formed by a series of straight additional segments extending on either side of the guide segments 140, 142 to the tip 114 and the base 116 of the tucker element. It will be further noted, from an examination of FIG. 5, that the tucker element 102 has a greater width W across the tucker guide surfaces in a direction perpendicular to the tucker central plane A-A than at either the tip 114 or the base 116 of the tucker element. In other embodiments of the invention, the sidewalls of a tucker element may have different shapes than the shape specifically shown in FIG. 5 and other illustrations herein. Preferably, the widest portion of the tucker element 102, in a direction extending orthogonal to central plane A-A, is between guide segments 140, 142 and is also aligned with the outward facing tucker element positioning surfaces 128, 130. More particularly, the widest portion of the guide segments 140, 142 is centered upon the outward facing tucker element positioning surfaces 128, 130. In other words, the widest portion of the tucker element 102 and the outward facing tucker element positing surfaces 128, 130 are at the same position along central plane A-A between the tip 114 and the base 116 (i.e. the outward facing tucker element position surfaces 128, 130 and the widest portion intersect the central plane A-A at the same location between the tip 114 and base 116. This configuration forces the rocking action to occur at the widest portion of the guide segments 140, 142 and positioning surfaces 128, 130 to avoid a wedging action between the tucker element 102 and sidewalls 216, 218 during the rocking and sliding motion thereof discussed more fully below. By reducing wedging, wear on the tucker element 102 and the sidewalls 216, 218 can be reduced.

In the exemplary embodiment of the tucker apparatus 100, the width W of the tucker element across the tucker guide surfaces 140, 142 is less than the width of the space between the first slot sidewall 216 and the pseudo-slot sidewall 144, in order to provide clearance between the tucker element 102 and those surfaces. The amount of clearance provided may vary in differing embodiments of the invention. It is desirable that the tucker element of a moveable tucker apparatus 100 according to the invention be free to move to the greatest extent possible within the slot 204.

In the exemplary embodiment, the clearance is relatively small such that the tucker element 102 includes dust grooves 139 formed in sidewalls 136, 138. These dust grooves 139 will reduce dust buildup between slot sidewalls 216, 218 and corresponding tucker sidewalls 136, 138 radially outward from the location where the slot sidewalls 216, 218 interact with tucker guide surfaces 140, 142. Dust buildup at those locations could inhibit the free motion of the tucker element 102 within the slot 204 of roll 202.

It is not essential for operation of the invention that the guide segments 140, 142 of the tucker element be tightly constrained by the sidewalls 216 and 144. The interaction between the guide segments 140, 142 and the sidewalls 216, 244 serves primarily to bring the tip 114 of the tucker element back to a known position with the central plane A-A of the tucker element 102 aligned parallel to the central plane 222 of the slot 204 and aligned with rotational axis 210, after the tip 114 of the tucker disengages with a corresponding gripper on the opposite folding roll, so that the tucker element 102 will be properly aligned for smooth engagement with a corresponding gripper on the subsequent interaction between the tucker and its corresponding gripper.

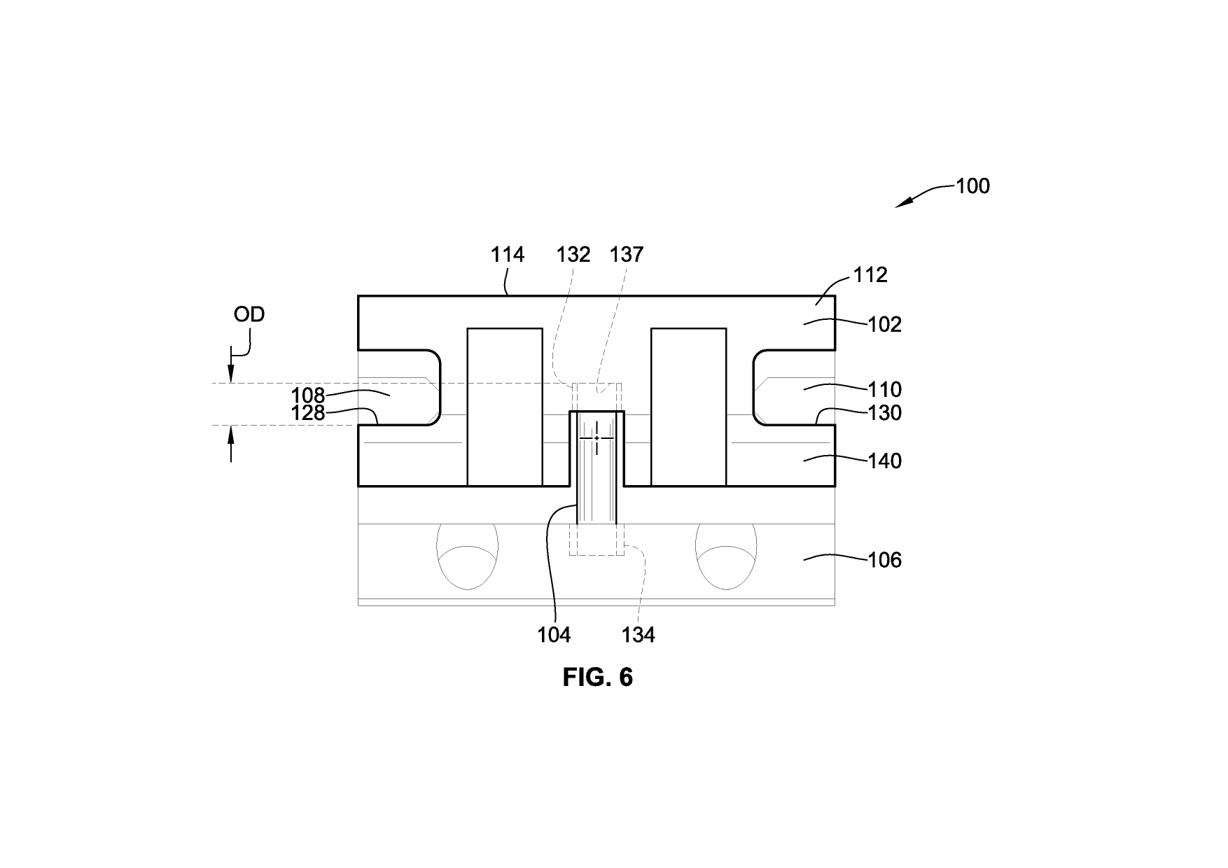

As further illustrated in FIG. 6, in the exemplary embodiment of the tucker element 102, the tucker element 102 has been configured such that the spring 104 engages an abutment having an abutment surface 137 forming a bottom of recess 132 of the tucker element 102 above (i.e. radially outward from) the outward facing tucker element positioning surfaces 128, 130. More particularly, the abutment surface 137, i.e. where the outer end of spring 104 contacts the tucker element 102, is radially offset from the outward facing tucker element positioning surfaces 128, 130 an offset distance OD. Because of this offset, in this embodiment, the abutment surface 137 is positioned closer to the tip 114 than outward facing tucker element positioning surfaces 128, 130. This orientation has also been shown to provide more desirable motion characteristics to the tucker element 102 than can be achieved with prior tucker arrangements. Further, this gives the spring 204 better mechanical advantage to return the tucker element 102 to a resting position with the inward and outward facing tucker element positioning surfaces 120, 122, 128, 130 engaged. While this configuration is preferred, alternative embodiments need not include this configuration

In the first exemplary embodiment of the tucker apparatus 100, the tucker mounting arrangement 106 also includes a series of fluid passages extending generally radially outward through the mounting arrangement 106 to provide fluid communication between fluid passages in the roll 202 and a series of fluid ports 146 positioned adjacent to the tip 114 of the tucker element 102 when the tucker apparatus 100 is mounted in the slot 204. These fluid ports 146 and the associated passages can be utilized in the manner known in the art for applying vacuum or air pressure at the ports 146 adjacent the tip 114 of the tucker to facilitate management of the material being folded as it is processed through the folding rolls 200. Other embodiments of the invention may or may not include such fluid ports and passages.

FIGS. 7-11, and FIGS. 7A-11A, sequentially illustrate operation of the first exemplary embodiment of the movable tucker apparatus 100 when mounted in and functioning as part of a folding roll apparatus, according to the second exemplary embodiment of the folding roll apparatus 200. In FIGS. 7-11, the second exemplary embodiment of the folding roll apparatus 200 is shown in operation with a mating, essentially identical folding roll apparatus 201. The mating folding roll apparatus 201 has the grippers and the tuckers essentially reversed in orientation in comparison to the first folding roll apparatus 200, and the folding rolls apparatuses 200, 201 are timed to one another to cause a gripper from one of the roll apparatuses 200, 201 to interact with a tucker 100 from the opposite one of the folding roll apparatuses 200, 201.

FIGS. 7 and 7A show the folding roll apparatuses 200, 201 in an orientation where the tip 114 of the tucker 100 is rotationally located about 2° before the nip formed between the outer circumferential surfaces of the folding roll apparatuses 200, 201 along a common center plane intersecting the rotational axes of the two folding roll apparatuses 200, 201. The gripper 206 associated with the movable tucker apparatus 100 is also positioned approximately 2° before the nip and is just beginning to close.

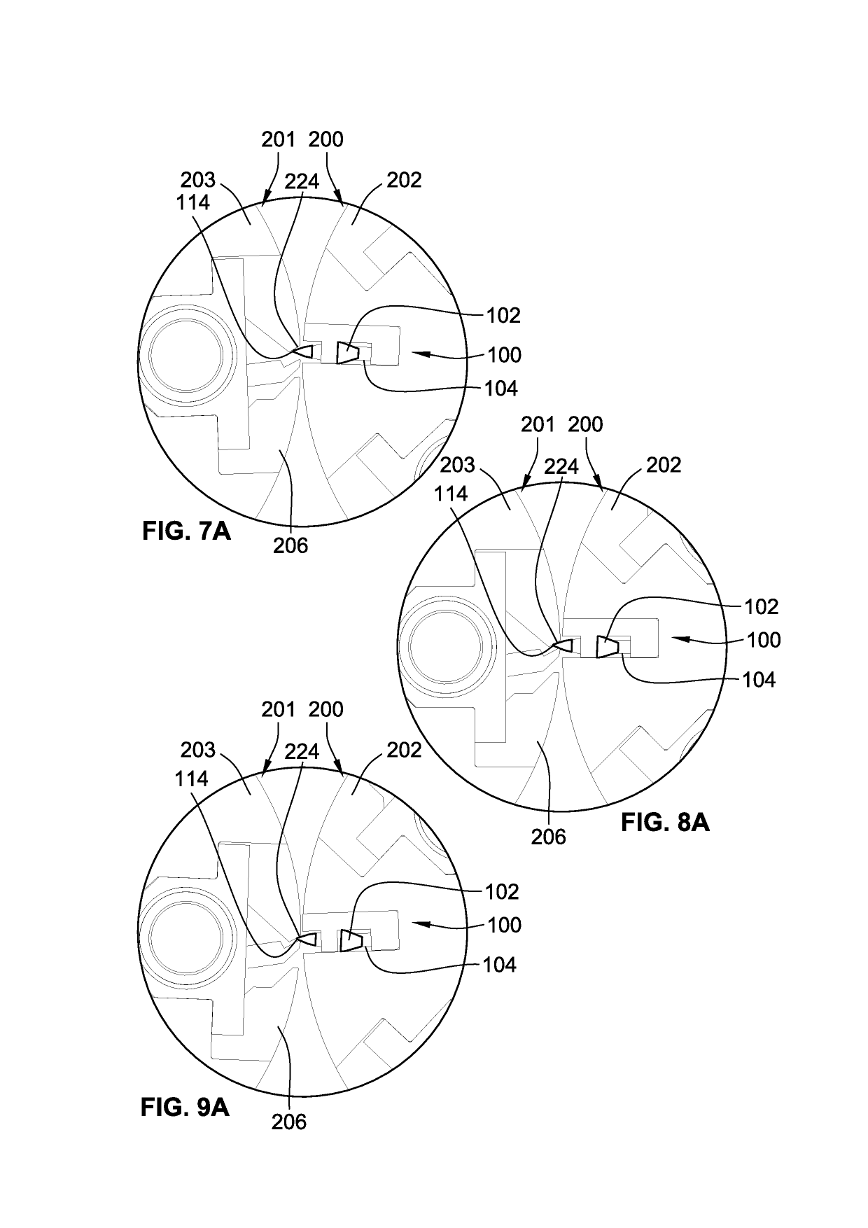

In FIGS. 8 and 8A, the tip 114 of the tucker 100 has contacted its corresponding gripper 206, and the gripper 206 has begun to close. As illustrated in FIGS. 8 and 8A, the tucker element 102 has moved out of its resting position with the inward and outward facing surfaces 120, 122, 128, 130 being held in full contact with each other by the spring 104. The actual motion taken by the tucker element is complex and based on a number of factors including the timing between folding roll apparatuses 200, 201 and the geometry of the gripper 206, tucker apparatus 100.

The motion of the tucker element 102 at the point in rotation shown in FIGS. 8 and 8A may, at first, seem counter-intuitive, in that the tip 114 of the tucker 102 has moved in a direction opposite to the direction of rotation of the folding roll apparatuses 200, 201. As will be understood by those having skill in the art, this “backwards” rotation of the tip 114 of the tucker 102 occurs because the tips 114 of the tuckers 102 in the exemplary embodiments of the invention 100, 200 illustrated herein have the tucker tip 114 arranged to extend outward beyond the outer circumference of the folding rolls 202, 203 of the folding roll apparatuses 200, 201, whereas the gripper elements 206 are disposed at or below the circumferential surfaces of folding rolls 202, 203 of the folding roll apparatuses 200,201. Because the tip 114 of the tucker is disposed farther outward from the rotational center of folding roll 202 than the gripper 206 in roll 203, the tip 114 of the tucker element 102 has a higher tangential speed than its associated gripper 206 when the tip 114 of the tucker 102 is not in contact with the gripper 206. When the tip 114 of the tucker element 102 comes into contact with the gripper 206, the tip 114 of the tucker element 102 must slow down, thereby causing the tucker element 102 to essentially rotate backwards relative to roll 202 and the direction of rotation of roll 202. It is therefore, desirable that a movable tucker element be freely capable of making this backwards movement, and also be freely capable of moving radially inward in a manner that allows the gripper 206 to close as smoothly as possible, preferably in one single continuous motion.

Those having skill in the art will recognize that the structural shapes and connections between the elements of the present invention allow the tucker element 102 to be more freely movable than was achievable with prior movable tucker arrangements. FIGS. 8B and 8C illustrate that the movable tucker apparatus 100 of the present invention provides for more freedom of movement by the tucker element 102 by eliminating the reliance upon a fixed pivot point for tucker element movement as is required in prior tucker arrangements. For example, as illustrated in FIG. 8B, the timing between the folding roll apparatuses 200, 201 is such that the tucker element 102 initially rocks along the interface between the inward and outward facing tucker element positioning surfaces 122, 130. As illustrated in FIG. 8C, once the tucker element 102 has moved deeper into the slot in the folding roll apparatus 200, if additional rotation of the tucker element tip 114 is required, the first guide segment 140 of the tucker element 102 may rock against the first sidewall 216 of the slot in the folding roll 200, and/or the second guide segment 142 may rock against the pseudo-slot sidewall 144.

Alternatively, depending upon the configuration, geometry, timing and/or accidental mistiming of the folding roll apparatuses 200, 201, the tucker element 102 may be initially pushed directly radially inward, in the manner illustrated in exaggerated fashion in FIG. 8D, and subsequently rock against the first sidewall 216 of the roll 202 or the pseudo-slot sidewall 144 of the tucker element mounting arrangement 106.

In an overall sense, it will be appreciated that a movable tucker apparatus according to the invention provides unparalleled freedom of movement of the movable tucker element 102 as compared to prior movable tucker approaches having a more constrained structure for guiding a movable tucker element. The additional freedom of movement provided by the present invention has been shown to allow the gripper 206 to close in a much smoother manner than can be achieved with prior movable tucker approaches.

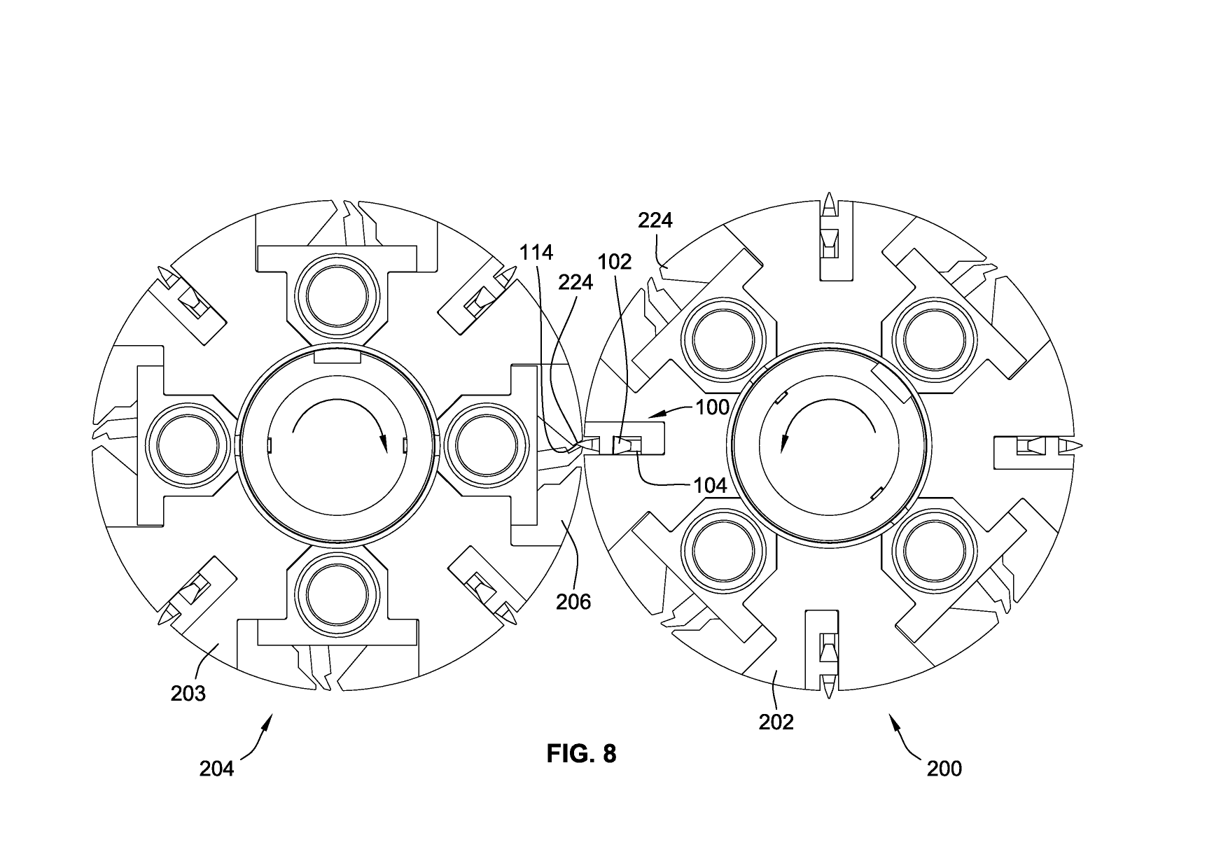

FIGS. 9 and 9A show the tucker element 102 and gripper 206 at a position approximately 2° after the nip. The tucker element 102 is pushed back into the slot in roll 200. The distance that the tucker element 102 is pushed back into the roll 202, and speed with which the tucker element 102 moves back into the roll 202 are dictated by the force of springs in the gripper arrangement 206 relative to the force generated by the spring 104 in the movable tucker apparatus 100. It is preferable that these spring forces be selected to provide an interaction in which the gripper 206 closes in one smooth motion.

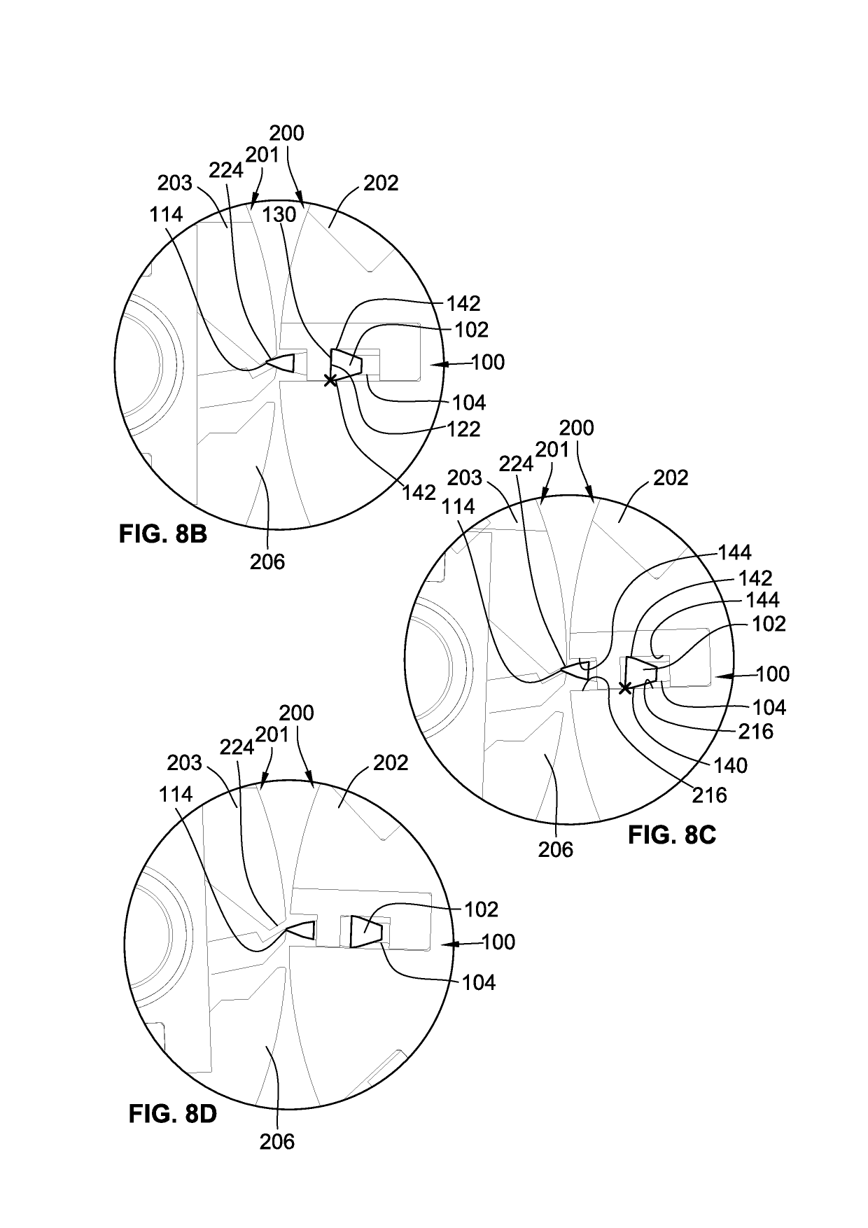

FIGS. 10 and 10A show the movable tucker apparatus 100 and the gripper arrangement 206 at a position approximately 4° after passing through the nip between the folding roll apparatuses 200, 201. At this point, the gripper arrangement 206 is completely closed, and the tip 114 of the tucker element 102 has been forced out of the gripper 206. Those having skill in the art will recognize that the present invention allows the gripper 206 to close essentially without any hindrance from the interaction with, and the motion of, the tucker element 102.

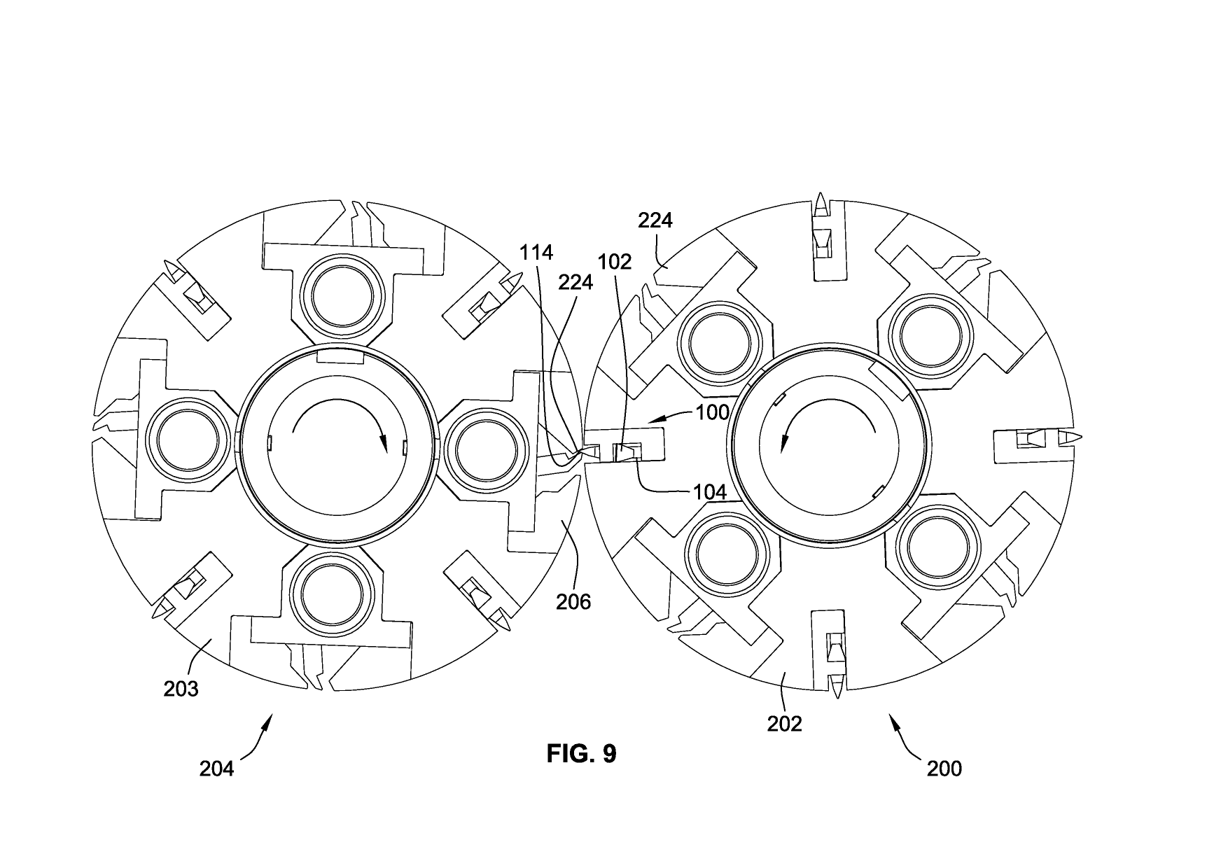

FIGS. 11 and 11A show the movable tucker apparatus 100 and gripper 206 at a rotational position approximately 19 degrees passed the nip between the folding roll apparatuses 200, 201. At this point, the tucker element spring 104 has caused the tucker element 102 to move back radially outward to a resting position with the radially outward facing surface 130 of the tucker element 102 resting fully against the radially inward facing surface 122 of the tucker element positioning lug 110. As the tucker element 102 is urged outward by the spring 104, the interaction between the inward and outward facing surfaces 122, 130, and the first and second guide segments 140, 142 of the tucker element 102 with the first sidewall 216 of the roll 202 and the pseudo-slot sidewall 144 of the tucker mounting arrangement 106 cooperate to position the tip 114 of the tucker element 102 for a proper engagement with its corresponding gripper arrangement on the next rotation of the folding roll apparatuses 200, 201.

FIGS. 12-17 illustrate several other exemplary embodiments of a movable tucker apparatus, according to the invention.

FIG. 12 shows a third exemplary embodiment of the invention, in the form of a movable tucker arrangement 300 having a pair of tucker springs 304, 305 disposed between a tucker element 302 and a tucker mounting arrangement 306. As further shown on FIG. 12, the inward and outward facing surfaces 322, 330 are formed from multiple angled segments.

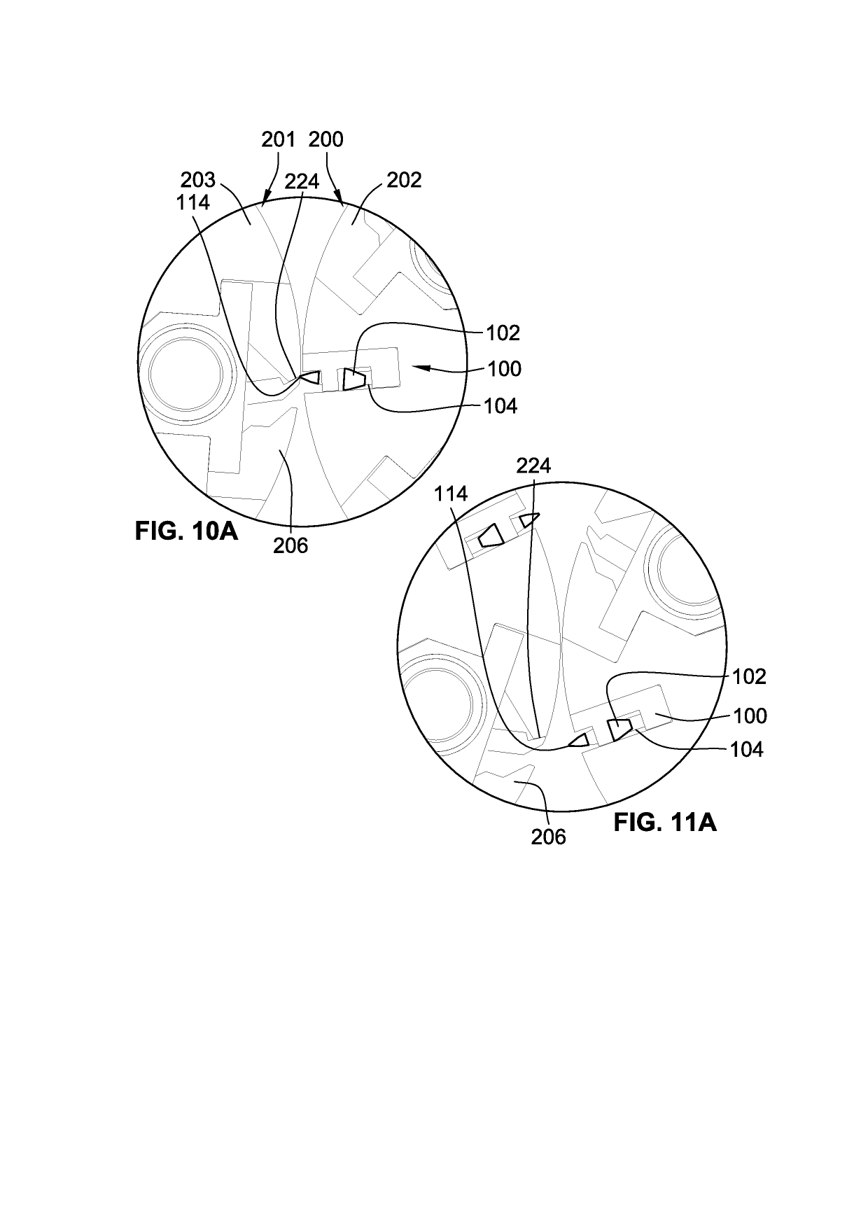

FIG. 13 shows a fourth exemplary embodiment of the invention, in the form of a movable tucker apparatus 400 having a single tucker spring 404, and inward and outward facing tucker element positioning surfaces 422, 430 which are formed from multiple angled segments.

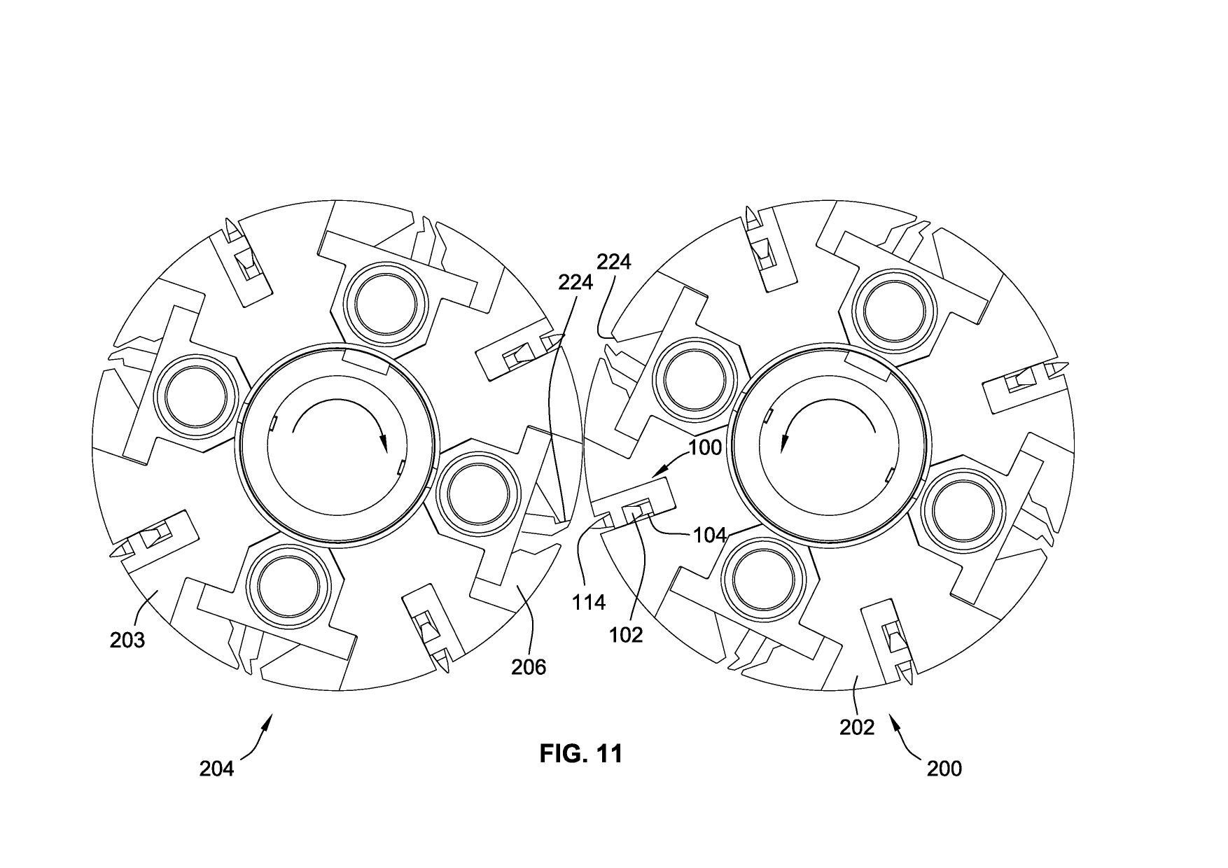

FIG. 14 shows a fifth exemplary embodiment of the invention, in the form of a movable tucker apparatus 500 in which the radially inward and outward facing tucker element positioning surfaces 522, 530 have a curved configuration.

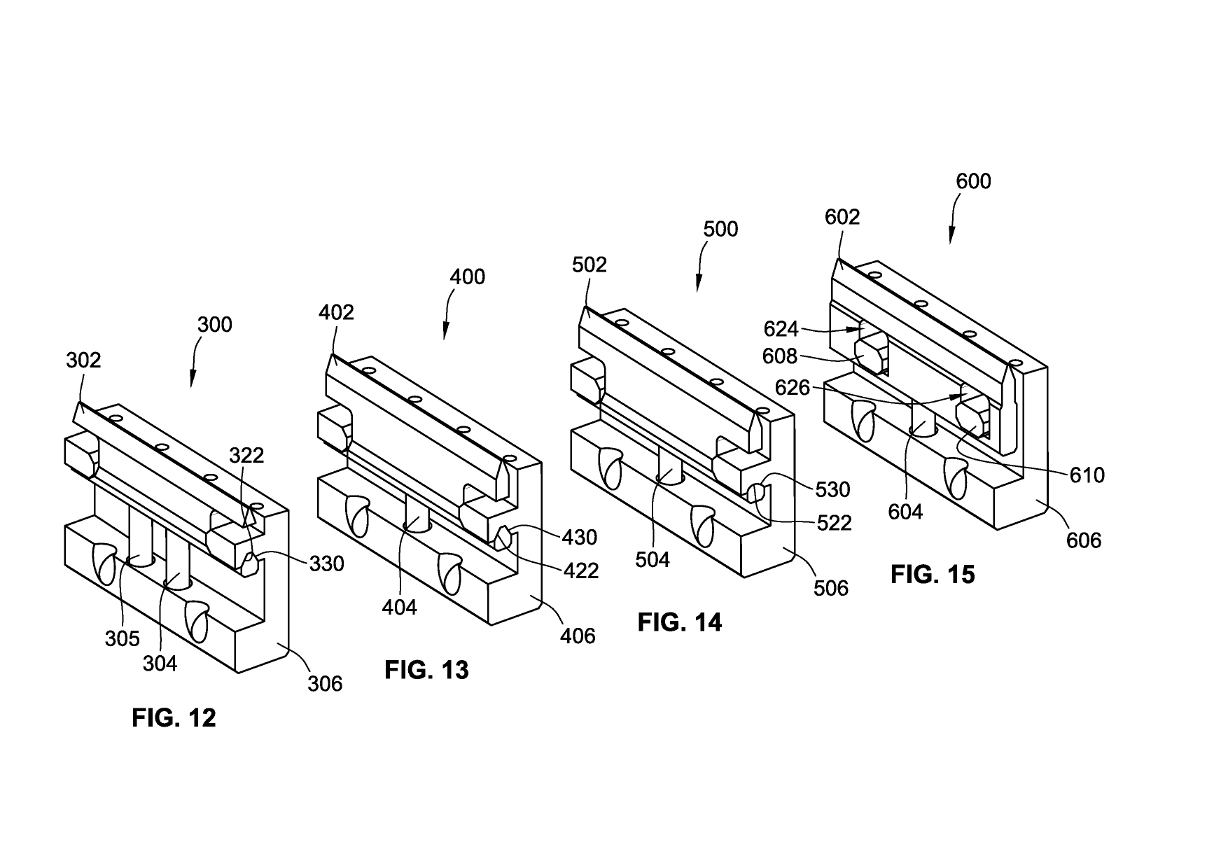

FIG. 15 shows a sixth exemplary embodiment of the invention, in the form of a movable tucker apparatus in which the recesses 624, 626 of the tucker element 602 are not disposed at the ends of the tucker element 602, and therefore, take the form of through-holes rather than the outwardly opening slots shown in the first, third, fourth and fifth exemplary embodiments of a movable tucker apparatus 100, 300, 400, 500.

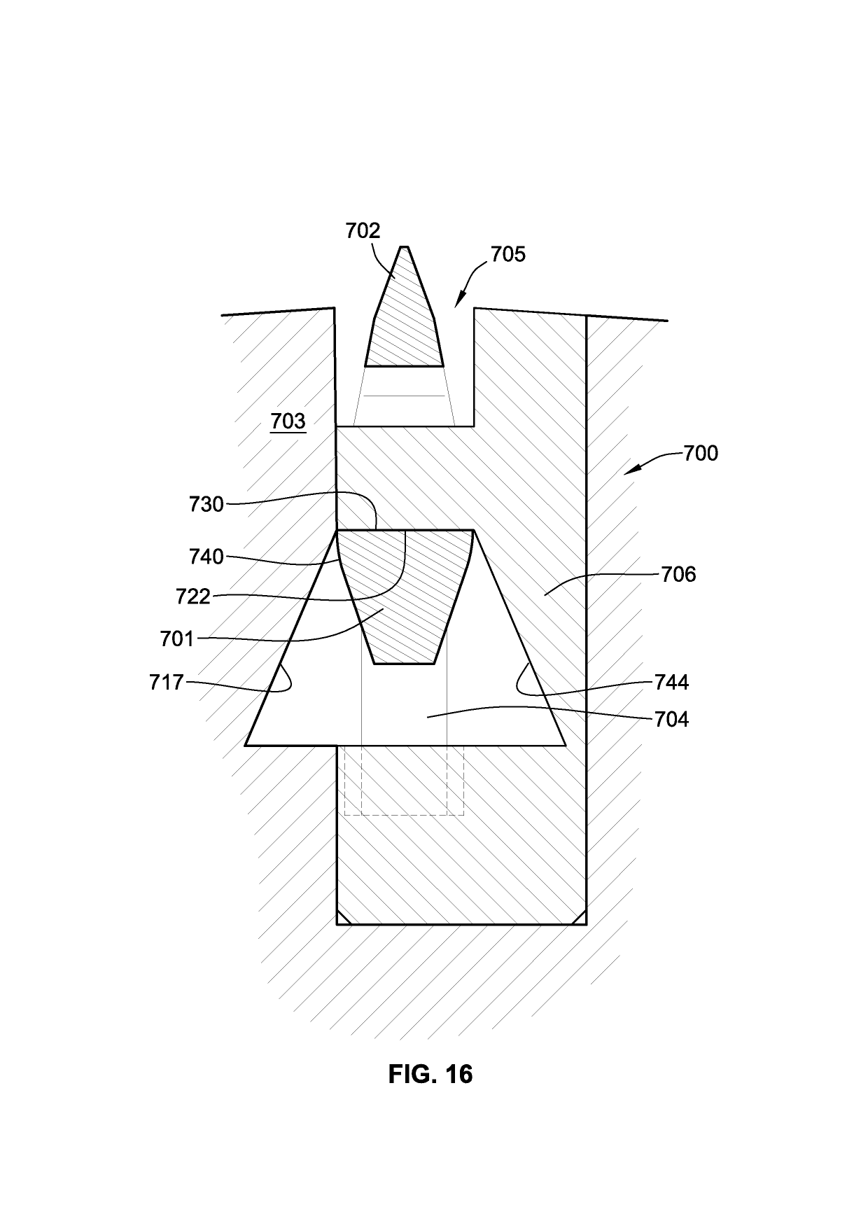

FIG. 16 shows a seventh exemplary embodiment of a movable tucker apparatus 700, according to the invention. In the seventh exemplary embodiment 700, the first slot sidewall 717 in a roll 703, and a pseudo-slot wall 744 of a tucker mounting arrangement 706 are angled away from the tucker element 702 below the radially inward and outward facing tucker element positioning surfaces 722, 730, to thereby provide additional clearance for enhanced freedom of movement for the tucker element 702. In other embodiments of the invention, a similar approach may be taken with the slot sidewall 717 and pseudo-sidewall 744, or a slot sidewall being configured in some manner other than a straight angled surface to provide additional movement capability for the tucker element 702. For example, the surfaces 717, 744 could be curved or formed by multiple segments in other embodiments of the invention.

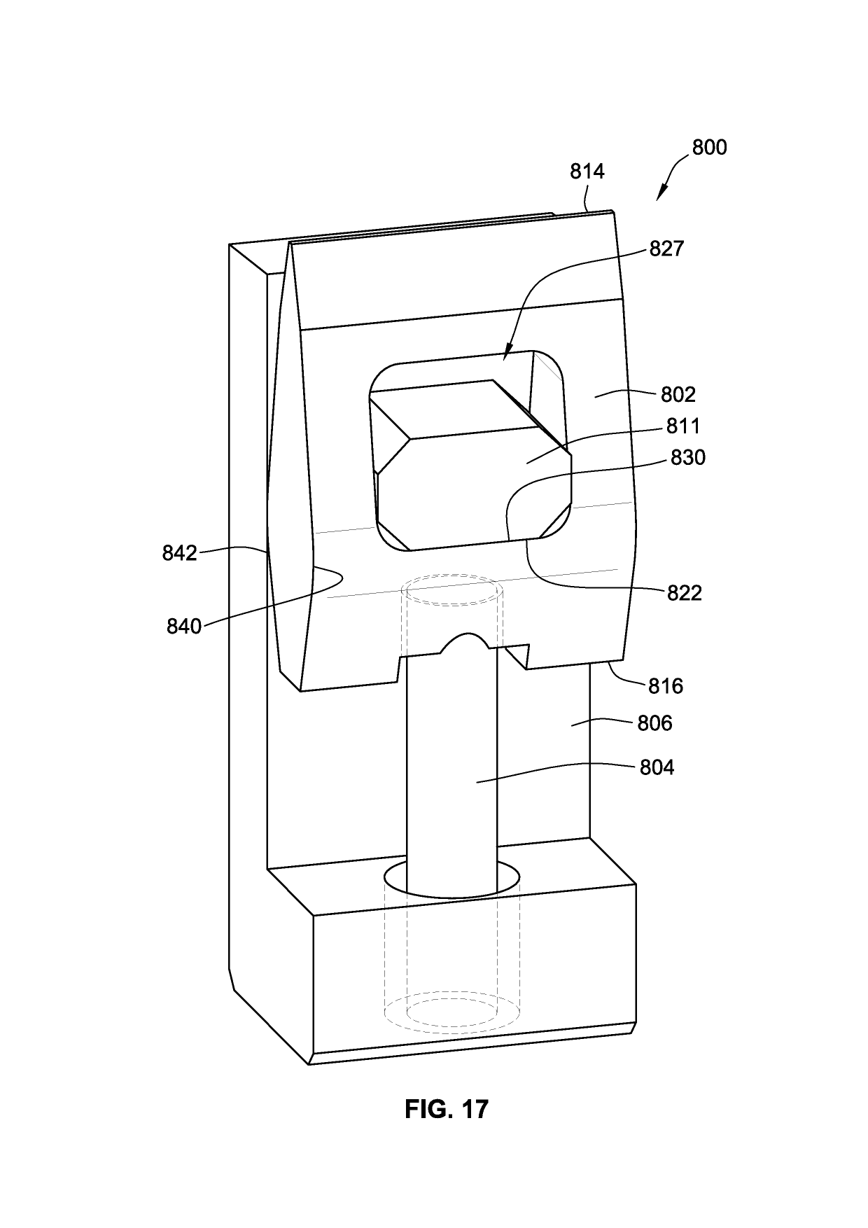

FIG. 17 shows an eighth exemplary embodiment of the invention, in the form of a moveable tucker apparatus 800 having a tucker element 802 operatively connected to a tucker element mounting arrangement 806 with a single spring 804 and a single tucker positioning lug 811 extending through a relief 827 in the form of a through-hole extending completely through the tucker element 802. An outward facing tucker element positioning surface 830 bounds the through-hole and cooperates with an inward facing tucker element positioning surface 822 formed by lug 811. It should be noted, that the outward facing tucker element positioning surface 830 is again positioned at the widest portion of the tucker element 802, formed by guide segments 840, 842.

While it is preferred to have the spring contact the tucker element above (i.e. radially outward from) the outward facing tucker element positioning surface as discussed with regard to prior embodiments, this embodiment allows for use when the longitudinal length of the tucker element 802 is so short that two separate reliefs cannot be formed in the tucker element 802 such that the spring 804 can be positioned between the reliefs.

Although all of the exemplary embodiments of moveable tucker apparatuses disclosed herein have utilized either one or two tucker positioning lugs, it will be understood that other embodiments of the invention may utilize more than two tucker positioning lugs.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A movable tucker apparatus for a folding roll defining an outer circumferentially extending surface of the roll and a rotational axis of the folding roll and having a longitudinal length of the roll extending between first and second axial ends of the roll, with the folding roll also having therein an outwardly opening tucker slot having a slot length extending along the rotational axis of the roll, the slot also defining opposite sidewalls of the slot spaced from one another by a slot width and joined to one another by a bottom surface of the slot with a distance from the bottom of the slot to the outer surface of the roll defining a depth of the slot, the tucker apparatus comprising:
a tucker element having a tip and base at opposite ends thereof;
a tucker spring; and
a tucker positioning lug configured for operative mounting the tucker element within the slot in the folding roll;
the tucker positioning lug being operatively affixed to the roll within the slot and extending outward into the slot in a direction away from at least one of the slot sidewalls at least partly across the width of the slot; and
the tucker element including a relief for operative receipt therein of the tucker positioning lug;
with the tucker element, tucker positioning lug and spring being cooperatively configured in a manner allowing the tucker element to move radially in and out within the slot relative to the rotational axis of the roll, and the tip of the tucker element to move circumferentially with respect to the slot in the roll when the tucker element is operatively mounted in the slot and the tucker positioning lug operatively disposed within the relief in the tucker element.

2. The apparatus of claim 1, wherein:
the tucker spring is positioned radially inward from the tip of the tucker element and urges the tucker element to move in a radially outward direction.

3. The apparatus of claim 2, wherein, the tucker element and tucker positioning lug define cooperating positioning surfaces thereof for limiting outward movement of the tucker element, and the positioning surface on the tucker positioning lug is disposed radially outward from the positioning surface on the tucker element.

4. The apparatus of claim 3, wherein, the tucker element defines an abutment against which the tucker spring acts to urge the tucker element in the radially outward direction, the abutment being positioned radially outward further than the positioning surface of the tucker element such that the abutment is positioned radially closer to the tip of the tucker element than the positioning surface of the tucker element.

5. The apparatus of claim 1, wherein, the tucker element and tucker positioning lug define cooperating positioning surfaces thereof for limiting outward movement of the tucker element, and the positioning surface on the tucker positioning lug is disposed radially outward from the positioning surface on the tucker element.

6. The apparatus of claim 5, wherein, the tucker element defines an abutment against which the tucker spring acts, the tucker spring biasing the tucker element in a radially outward direction relative to the rotational axis of the roll, the abutment being positioned radially outward further than the positioning surface of the tucker element such that the abutment is positioned radially closer to the tip of the tucker element than the positioning surface of the tucker element.

7. The apparatus of claim 1, wherein, the relief extends entirely through the tucker element.

8. The apparatus of claim 7, wherein, the relief opens outwardly along the rotational axis of the roll at an end of the tucker element.

9. The apparatus of claim 7, wherein, the relief is a through-hole extending through the tucker element at a location other than an end of the tucker element.

10. The apparatus of claim 5, wherein the tucker element has first and second sidewalls extending between the tip and the base on opposed sides of the tucker element, the first sidewall defining a first guide segment, the second sidewall defining a second guide segment, the tucker element having a maximum width between the first and second sidewalls being provided between the first and second guide segments.

11. The apparatus of claim 10, wherein the positioning surface on the tucker element is radially positioned relative to the rotational axis at the maximum width of the tucker element.

12. The movable tucker apparatus of claim 1, wherein
the tucker element defines a tucker central plane extending longitudinally through the tip and base, the tucker element defining a tucker element length between the tip and the base of the of the tucker element that is less than the slot depth;
the tucker positioning lug having a depth less than the depth of the slot the tucker positioning lug further having an inward facing tucker element positioning surface facing the bottom of the slot and configured for engagement with the tucker element;
the relief having a length along the tucker central plane greater than the depth of the tucker positioning lug, the relief also defining at a radially inner end thereof an outward facing tucker element positioning surface configured for operative engagement with the inward facing tucker element positioning surface of the positioning lug for limiting outward movement of the tucker element within the slot; and
the spring being operatively disposed between the roll and the tucker body for urging the tucker element outward toward engagement of the outward facing tucker positioning surface of the tucker element relief with the inward facing tucker positioning surface of the tucker positioning lug.

13. The apparatus of claim 12, wherein the inward and outward facing tucker element positioning surfaces are further configured for facilitating movement of tip of the tucker element circumferentially with respect to the slot.

14. The apparatus of claim 12, wherein, the inward and outward facing tucker positioning surfaces extend substantially transversely relative to the central plane of the slot when in engagement with one another.

15. The apparatus of claim 14, wherein, the inward and outward facing tucker positioning surfaces are flat and extend substantially perpendicular relative to the central plane of the slot when in engagement with one another.

16. The apparatus of claim 14, wherein, the inward and outward facing tucker positioning surfaces have a shape from the group of shapes consisting of: flat, curved, multifaceted, and angled.

17. The apparatus of any of claim 12, wherein, the tucker element body is spaced from the slot sidewalls.

18. The apparatus of any of claims 12, wherein:
the tucker element body includes first and second sidewalls thereof adjacent, respectively, the first and second slot sidewalls; and
the first and second sidewalls of the tucker element have tucker guide segments thereof, disposed adjacent the outward facing tucker element positioning surface, configured for sliding engagement with the slot sidewalls.

19. The apparatus of claim 18, wherein, the tucker guide segments are convex.

20. The apparatus of claim 19, wherein, the body of the tucker element has a greater width between the tucker guide surfaces in a direction perpendicular to the tucker central plane than a width at either the tip or the base of the tucker element.

21. The apparatus of claim 20, wherein, the width between the tucker guide surfaces is less than the slot width by a clearance width, and wherein a maximum width between the first and second sidewalls is defined between the first and second guide surfaces, and wherein the maximum width is positioned along the tucker central plane at a same location as the outward facing tucker element positioning surface.

22. The apparatus of claim 20, wherein, a portion of at least one of the first and second sidewalls of the tucker element body forms a substantially straight segment positioned between one of the tucker guide segments and the tip or the base of the tucker element.

23. The apparatus of claim 12, wherein, the spring engages the tucker element radially outward along the central plane further than the outward facing tucker positioning surface.

24. The apparatus of claim 12, wherein, the central plane passes through the rotational axis of the roll when the tucker element is positioned within the slot.

25. The apparatus of claim 12, further comprising, a tucker mounting arrangement configured for fixed installation into the slot in the roll and including the tucker positioning lug.

26. The apparatus of claim 25, wherein, the tucker mounting arrangement also includes at least one fluid passage extending therethrough to provide fluid communication between fluid passages in the roll and fluid ports in the mounting arrangement positioned adjacent to the tip of the tucker.

27. A folding roll apparatus comprising:
a folding roll;
a movable tucker arrangement; and
wherein:
the folding roll defines an outer circumferentially extending surface of the roll and a rotational axis of the folding roll and having a longitudinal length of the roll extending between first and second axial ends of the roll, with the folding roll also defining therein an outwardly opening tucker slot having a slot length extending along the rotational axis of the roll, with the slot also defining opposite sidewalls of the slot spaced from one another by a slot width and joined to one another by a bottom surface of the slot with a distance from the bottom of the slot to the outer surface of the roll defining a depth of the slot;
the movable tucker arrangement includes a tucker element having a tip and base at opposite ends thereof, a tucker spring and a tucker positioning lug configured for operative mounting within the slot in the folding roll;
the tucker positioning lug is operatively affixed to the roll within the slot and extends outward into the slot in a direction away from at least one of the slot sidewalls at least partly across the width of the slot;
the tucker element includes a relief for operative receipt therein of the tucker positioning lug; and
the tucker element, tucker positioning lug and spring are operatively connected in a manner allowing the tucker element to move in and out, and the tip of the tucker to move circumferentially with respect to the slot in the roll when the tucker element is operatively mounted in the slot and the tucker positioning lug operatively disposed within the relief in the tucker element.

28. A method for operating a folding roll apparatus comprising a folding roll and a movable tucker arrangement, wherein:
the folding roll defines an outer circumferentially extending surface of the roll and a rotational axis of the folding roll and having a longitudinal length of the roll extending between first and second axial ends of the roll, with the folding roll also defining therein an outwardly opening tucker slot having a slot length extending along a rotational axis of the roll, with the slot also defining opposite sidewalls of the slot spaced from one another by slot width and joined to one another by a bottom surface of the slot with a distance from the bottom of the slot to the outer surface of the roll defining a depth of the slot;
the movable tucker arrangement includes a tucker element having a tip and base at opposite ends thereof, a tucker spring and a tucker positioning lug configured for operative mounting within the slot in the folding roll;
the tucker positioning lug is operatively affixed to the roll within the slot and extends outward into the slot in a direction away from at least one of the slot sidewalls at least partly across the width of the slot;
the tucker element includes a relief for operative receipt therein of the tucker positioning lug;
the tucker element, tucker positioning lug and spring are operatively connected in a manner allowing the tucker element to move in and out, and the tip of the tucker to move circumferentially within the slot in the roll when the tucker element is operatively mounted in the slot and the tucker positioning lug operatively disposed within the relief in the tucker element; and
the method comprises:
operating the folding roll with the tucker element operatively mounted in the slot and the tucker positioning lug operatively disposed within the relief in the tucker element in a manner causing the tucker element to move in one or more of the motions in the group of motions consisting of: in and out within the slot; and such that the tip of the tucker moves circumferentially with respect to the slot in the roll.

29. The apparatus of claim 3, wherein the tucker element and tucker positioning lug define cooperating stop surfaces thereof for limiting inward movement of the tucker element toward the bottom of the slot, and the stop surface on the tucker positioning lug is disposed radially inward from the stop surface on the tucker element.

30. The apparatus of claim 29, wherein the stop surfaces are configured to allow the tip of the tucker element to be fully pressed into the slot such that the tip does not extend outward beyond the outer surface of the roll.
